(19) United States
(12) Patent Application Publication
(10) Pub. No.: US 2018/0137219 A1
(43) Pub. Date: May 17, 2018

(54) FEATURE SELECTION AND FEATURE SYNTHESIS METHODS FOR PREDICTIVE MODELING IN A TWINNED PHYSICAL SYSTEM

(71) Applicant: General Electric Company, Schenectady, NY (US)

(72) Inventors: Helena GOLDFARB, Niskayuna, NY (US); Achalesh PANDEY, San Ramon, CA (US); Weizhong YAN, Clifton Park, NY (US)

(21) Appl. No.: 15/350,665

(22) Filed: Nov. 14, 2016

(51) Int. Cl. G06F 17/50; G06N 99/00

(52) U.S. Cl. CPC G06F 17/5009; G06N 99/005

(57) ABSTRACT

Systems and methods for predictive modeling of an industrial asset. In some embodiments, a database stores an electronic file containing a machine learning library and predictive modeling tools associated with the industrial asset. A computer processor accesses the machine learning library and predictive modeling tools, provides a model building framework user interface and receives a selection of a feature engineering (FE) technique, including one of evolutionary feature selection, evolutionary feature synthesis, and symbolic regression. Next, an input selection interface is provided, industrial asset input data and parameter data received, and at least one of an evolutionary feature selection process, an evolutionary feature synthesis process, and a symbolic regression process is executed. At least one of feature selection output data and feature rankings output data associated with a predictive model of the industrial asset is generated, and in some implementations an output device receives and presents that data to a user.

### BACKGROUND

It is often desirable to model behaviors and/or make assessments and/or make predictions regarding the operation of a real world physical system, such as an electro-mechanical system. For example, it may be helpful to predict a Remaining Useful Life (“RUL”) of an electro-mechanical system, such as an aircraft engine or wind turbine, to help plan when the system should be replaced. Likewise, an owner or operator of such a system might want to monitor one or more conditions of the system, or one or more portions of the system, to help make maintenance decisions, budget predictions, and the like. Even with improvements in sensor and computer technologies, however, accurately making such assessments and/or predictions can be a difficult task. For example, an event that occurs while a system is not operating might impact the RUL and/or one or more conditions of the system but it may not be taken into account by typical approaches to system assessment and/or prediction processes.

Machine learning is a scientific discipline that deals with the construction and study of algorithms that can learn from data. Thus, data scientists leverage machine learning techniques to build models that make predictions from real data. The machine learning processes operate by building a model based on inputs and use that to make predictions or decisions, rather than following only explicitly programmed instructions. Typically, such a predictive model includes a machine learning algorithm that learns certain properties from a training dataset in order to make predictions. For example, regression models are based on the analysis of relationships between variables and trends in order to make predictions about continuous variables. For example, in weather forecasting a regression model could be used to predict the maximum temperature for an upcoming day or days.

Some predictive modeling processes utilize several preprocessing steps which are applied to raw data before machine learning models and/or machine learning algorithms are applied to the data. For example, data quality algorithms, such as imputations and/or outlier removal, as well as feature extraction algorithms, can be utilized. The feature extraction algorithms select features from the data, and/or make (synthesize) new features. Selected or synthesized features are used in training predictive models, and the better the features the better the accuracy of the model.

It would therefore be desirable to provide methods and systems that improve predictive modeling results for a physical system in an automatic and accurate manner.

### SUMMARY

According to some embodiments, an apparatus may implement a digital twin of a twinned physical system. One or more sensors may be used to monitor and/or sense values of one or more designated parameters of the twinned physical system, and a computer processor may receive data associated with the sensors. The computer processor may, for at least a selected portion of the twinned physical system, generate an accurate predictive model for at least a selected portion (or component) of the twinned physical system based at least in part on the sensed values and/or stored values of one or more designated parameters. The computer processor may also utilize the data and machine learning techniques to generate predictive models useful for making future decisions. In addition, a communication port operably connected to the computer processor may transmit information and/or reports associated with one or more results generated by the computer processor.

Some embodiments may include a system associated with predictive modeling of an industrial asset. Such a system may include a database storing at least one electronic file containing a machine learning library and a predictive modeling tools, which may be part of a software development kit (SDK) for example, associated with the industrial asset, a modeling platform including a computer processor and operatively connected to the database, and an output device operably connected to the computer processor. In some implementations, the computer processor is configured to access the machine learning library and predictive modeling tools associated with the industrial asset, provide a model building framework interface (for example, a graphical user interface (GUI) or an application programming interface (API)) to a user, receive a selection of a feature engineering (FE) technique comprising one of evolutionary feature selection, evolutionary feature synthesis, and symbolic regression, provide an input selection interface based on the selected FE technique, receive industrial asset input data and parameter data via the input selection interface from the user, execute at least one of an evolutionary feature selection process, an evolutionary feature synthesis process, and a symbolic regression process and generate output data for the industrial asset, and generate at least one of feature selection output data and provide feature rankings output data. The output device may then receive and present at least one of the generated feature selection output data and the feature rankings output data associated with a predictive model of the industrial asset to a user.

Other embodiments relate to a computerized method associated with predictive modeling of an industrial asset. In some implementations, the process includes a computer processor accessing a machine learning library and predictive modeling tools (which may be provided, for example, as a software development kit (SDK)) associated with an industrial asset, providing a model building framework interface (such as a graphical user interface (GUI) or as an application programming interface (API)) associated with the industrial asset to a user, receiving a selection of a feature engineering (FE) technique comprising one of evolutionary feature selection, evolutionary feature synthesis, and symbolic regression, providing an input selection interface (such as a GUI) based on the selected FE technique, receiving industrial asset input data and parameter input data via the input selection interface from the user, and executing at least one of an evolutionary feature selection process, an evolutionary feature synthesis process, and a symbolic regression process and generate output data for the industrial asset. In some implementations, the process also includes providing at least one of feature selection output data and feature rankings output data associated with a predictive model of the industrial asset for consideration by a user.

A technical advantage of some embodiments disclosed herein are improved systems and methods that facilitate predictive modeling of physical assets in an automatic manner, and result in accurate predictive models that can be used to make assessments and/or to take action(s) regarding such physical assets.

### BRIEF DESCRIPTION OF THE DRAWINGS

FIG. 1A is a high-level block diagram of a system that may be provided in accordance with some embodiments;

FIG. 1B is a digital twin method according to some embodiments;

FIG. 2A illustrates integration of some physical computer models in accordance with some embodiments;

FIG. 2B illustrates six modules that may comprise a digital twin according to some embodiments;

FIG. 3 illustrates an example of a digital twin's functions in accordance with some embodiments;

FIGS. 4A-4B form a screen shot of a digital twin (DT) model building framework graphical user interface (GUI) in accordance with some embodiments;

FIGS. 4C-4D form a screen shot of an Evolutionary Feature selection technique GUI of the type that a user of the DT model building framework would utilize to specify one or more parameters for a classification problem according to some embodiments;

FIGS. 4E-4F form a screen shot of an Evolutionary Feature selection technique summary output page according to some embodiments;

FIGS. 4G-4H form a screen shot of an Evolutionary Feature Synthesis GUI for providing input to reduce mathematical expression complexity and increase information gain of a feature in accordance with some embodiments;

FIGS. 4I-4J form a screen shot of an Evolutionary Feature synthesis technique summary output page according to some embodiments;

FIGS. 4K-4L form a screen shot of a symbolic regression GUI example of the type that a user would utilize to specify one or more parameters to obtain results in accordance with some embodiments;

FIGS. 4M-4N form a screen shot of a summary output page illustrating the types of output information provided to a user of a DT platform running the symbolic regression process via the parameters selected using the symbolic regression GUI of FIGS. 4K-4L in accordance with some embodiments;

FIG. 5A is a screen shot of a digital twin (DT) model building framework graphical user interface (GUI) for an evolutionary feature selection process to obtain predictive modeling results in accordance with some embodiments;

FIGS. 5B-5C is another screen shot of the DT model building framework GUI to illustrate an “Advanced Algorithm Parameters” section in accordance with some embodiments;

FIGS. 5D-5E form a screen shot of a summary page of results concerning the evolutionary feature selection process of FIGS. 5A-5C in accordance with some embodiments;

5F is a flowchart illustrating an example of an evolutionary feature selection process operable to select evolutionary features associated with a wind turbine in accordance with some embodiments;

FIG. 6 is a flowchart illustrating an example of an evolutionary feature synthesis process for generating new features from a multi-dimensional dataset associated with an aviation stall problem in accordance with some embodiments;

FIG. 7 is block diagram of a digital twin platform according to some embodiments of the disclosure;

FIG. 8 is a tabular portion of a digital twin database according to some embodiments of the disclosure; and

FIG. 9 illustrates an interactive graphical user interface display in accordance with some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

It is often desirable to model system behavior in order to make predictions and/or to make assessments regarding the operation of a real world physical system, such as an electro-mechanical system. For example, it may be helpful to predict when maintenance is required and/or the Remaining Useful Life (“RUL”) of an electro-mechanical system, such as an aircraft engine or wind turbine, to help plan when system maintenance procedure(s) should be performed and/or when the system should be replaced.

In general, and for the purpose of introducing concepts of novel embodiments described herein, presented herein are systems and methods for building predictive models of a physical system, or portion(s) thereof, which involve one or more preprocessing steps that enable feature selection guided by evolutionary algorithms. The preprocessing steps may include data quality algorithms, such as imputations and outlier removal, as well as feature extraction algorithms that select features from the data or make (synthesize) new features. In the disclosed embodiments, evolutionary feature selection and synthesis methods are applied to generate individual solutions at each generation and select or perform crossover of the individuals based on a given probability. The individual solutions are then evaluated and selected for next generation based on their fitness, as per objective functions. In addition, an option to approximate fitness of each individual is provided, instead of retraining a model for each individual in each generation, which option drastically reduces time-complexity of the algorithm(s) as compared to conventional techniques.

Accordingly, in some embodiments, several algorithms implemented in the Python software language are configured for use by a “digital twin” system of a twinned digital physical system, which may be referred to herein as a Digital Twin (DT) framework. Feature engineering (FE), which may be defined as a process of transforming raw data into features and/or of injecting domain knowledge, is critical to building accurate predictive models for the DT framework. Conventional or traditional FE processes involve manual steps, are ad hoc and time-consuming, and are not scalable. In contrast, the processes disclosed herein enable automation and scalability of the FE process resulting in more accurate predictive model building which is not as time consuming.

Accordingly, disclosed herein are a first algorithm that is utilized for feature selection, and a second algorithm that is utilized for feature synthesis and ranking. Each of these first and second algorithms are highly configurable and permit a user to define any number of objectives which should either be minimized or maximized. Such flexibility allows for injection of domain-specific knowledge, for example, to account for an unbalanced dataset. The algorithms are also fully configurable by a user from a DT user interface (which may be a graphical user interface (GUI)) which enables users to change any aspect(s) of the algorithm. For example, a user may configure one or both algorithms to account for an allowed run time, a number of features to select, a complexity of the mathematical expression, and/or other selections based on the domain knowledge of a problem at hand. Furthermore, the described algorithms are part of a common platform which enables them to be utilized as part of one or more machine learning pipelines and in automation, such as grid-search. In some implementations, the best solutions are collected and then the results are presented as a Pareto Front table and/or graphical charts.

In some embodiments, the disclosed processes can be advantageously used to find the minimal feature subset that maximizes performance of a classifier or regressor, and/or to find the mathematical expression that maximizes a multi-objective goal of a classifier or regressor. For example, the processes can be utilized to find the maximize number of true positives and the maximum number of true negatives, and/or can be used to maximize accuracy and/or minimize the number of false positives. In addition, the results can be used to rank features and/or to generate new features, without having to use conventional feature selection methods that rely on an exhaustive search (which can be exponential in time complexity). In particular, with conventional processes the number of features to choose has to be selected a priory. Accordingly, in order to explore all the combinations of features, wherein N is the number of features in the dataset and K is the number of features to be selected, a user has to repeat the same algorithm N choose K times (which can be on the order of N to the power of K), which can be very time intensive.

In order to aid in the understanding of the evolutionary feature selection and feature synthesis aspects and/or capabilities for a digital twin (DT) framework disclosed herein, presented below is an explanation of what constitutes a digital twin system and/or DT framework.

With the advancement of sensors, communications, and computational modeling, it may be possible to consider and/or model multiple components of a system, each having its own micro-characteristics and not just average measures of a plurality of components associated with a production run or lot. Moreover, it may be possible to very accurately monitor and continually assess the health of individual components, predict their remaining lives, and consequently estimate the health and remaining useful lives of systems that employ them. This would be a significant advance for applied prognostics, and discovering a system and methodology to do so in an accurate and efficient manner will help reduce unplanned down time for complex systems (resulting in cost savings and increased operational efficiency). It may also be possible to achieve a more nearly optimal control of an asset if the life of the parts can be accurately determined as well as any degradation of the key components. According to some embodiments described herein, this information may be provided by a “digital twin” (DT) of a twinned physical system.

A digital twin may estimate a remaining useful life of a twinned physical system using sensors, communications, modeling, history, and computation. It may provide an answer in a time frame that is useful, that is, meaningfully prior to a projected occurrence of a failure event or suboptimal operation. It might comprise a code object with parameters and dimensions of its physical twin's parameters and dimensions that provide measured values, and keeps the values of those parameters and dimensions current by receiving and updating values via outputs from sensors embedded in the physical twin. The digital twin may also be used to prequalify a twinned physical system's reliability for a planned mission. The digital twin may comprise a real time efficiency and life consumption state estimation device. It may comprise a specific, or “per asset,” portfolio of system models and asset specific sensors. It may receive inspection and/or operational data and track a single specific asset over its lifetime with observed data and calculated state changes. Some digital twin models may include a functional or mathematical form that is the same for like asset systems, but will have tracked parameters and state variables that are specific to each individual asset system.

A digital twin may be placed on a twinned physical system and run autonomously or globally with a connection to external resources using the Internet of Things (IoT) or other data services. Note that an instantiation of the digital twin's software could take place at multiple locations. A digital twin's software could reside near the asset and used to help control the operation of the asset. Another location might be at a plant or farm level, where system level digital twin models may be used to help determine optimal operating conditions for a desired outcome, such as minimum fuel usage to achieve a desired power output of a power plant. In addition, a digital twin's software could reside in the cloud, implemented on a server remote from the asset. The advantages of such a location might include scalable computing resources to solve computationally intensive calculations required to converge a digital twin model producing an output vector y̅.

It should be noted that multiple but different digital twin models for a specific asset, such as a wind turbine, could reside at all three of these types of locations. Each location might, for example, be able to gather different data, which may allow for better observation of the asset states and hence determination of the tuning parameters, ā, especially when the different digital twin models exchange information.

A “Per Asset” digital twin may be associated with a software model for a particular twinned physical system. The mathematical form of the model underlying similar assets may, according to some embodiments, be altered from like asset system to like asset system to match the particular configuration or mode of incorporation of each asset system. A Per Asset digital twin may comprise a model of the structural components, their physical functions, and/or their interactions. A Per Asset digital twin might receive sensor data from sensors that report on the health and stability of a system, environmental conditions, and/or the system's response and state in response to commands issued to the system. A Per Asset digital twin may also track and perform calculations associated with estimating a system's remaining useful life.

A Per Asset digital twin may comprise a mathematical representation or model along with a set of tuned parameters that describe the current state of the asset. This is often done with a kernel-model framework, where a kernel represents the baseline physics of operation or phenomenon of interest pertaining to the asset. The kernel has a general form of:

y̅=ƒ(ā,x̅)

where ā is a vector containing a set of tuning parameters that are specific to the asset and its current state. Examples may include component efficiencies in different sections of an aircraft engine or gas turbine. The vector x̅ contains the kernel inputs, such as operating conditions (fuel flow, altitude, ambient temperature, pressure, etc.). Finally, the vector y̅ is the kernel outputs which could include sensor measurement estimates or asset states (part life damage states, etc.).

When a kernel is tuned to a specific asset, the vector ā is determined, and the result is called the Per Asset digital twin model. The vector ā will be different for each asset and will change over its operational life. The Component Dimensional Value table (“CDV”) may record the vector ā. It may be advantageous, for example, to keep all computed vector ā's versus time to then perform trending analyses or anomaly detection.

A Per Asset digital twin may be configured to function as a continually tuned digital twin, a digital twin that is continually updated as its twinned physical system is on-operation, and/or an economic operations digital twin used to create demonstrable business value. In addition, a Per Asset digital twin can be configured to function as an adaptable digital twin that is designed to adapt to new scenarios and new system configurations and may be transferred to another system or class of systems, and/or one of a plurality of interacting digital twins that are scalable over an asset class and may be broadened to not only model a twinned physical system but also provide control over the asset. In a particular example, the Predix™ platform available from the General Electric Company (GE) is a novel embodiment of a digital twin technology (or an Asset Management Platform (AMP) technology) enabled by state of the art, cutting edge tools and cloud computing techniques that enable incorporation of a manufacturer's asset knowledge with a set of development tools and best practices that enables asset users to bridge gaps between software and operations to enhance capabilities, foster innovation, and ultimately provide economic value. Through the use of such a system, a manufacturer of industrial assets can be uniquely situated to leverage its understanding of industrial assets themselves, models of such assets, and industrial operations or applications of such assets, to create new value for industrial customers through asset insights.

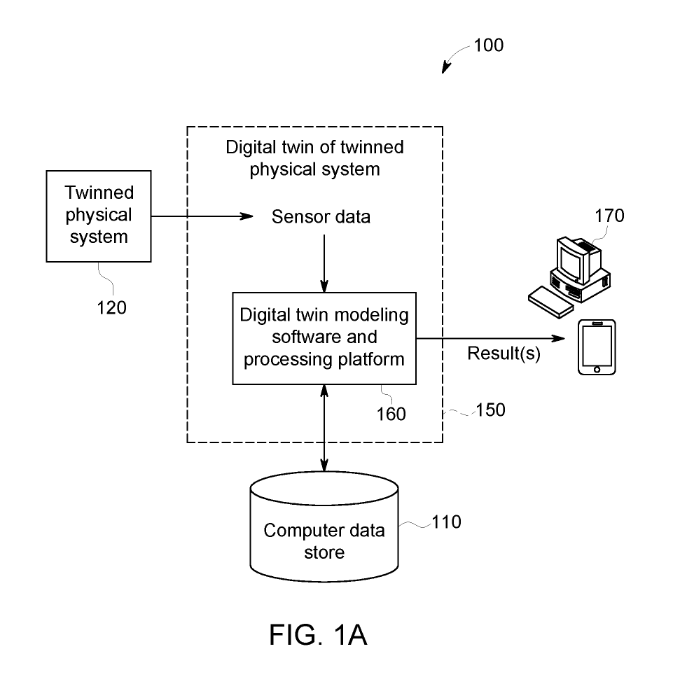

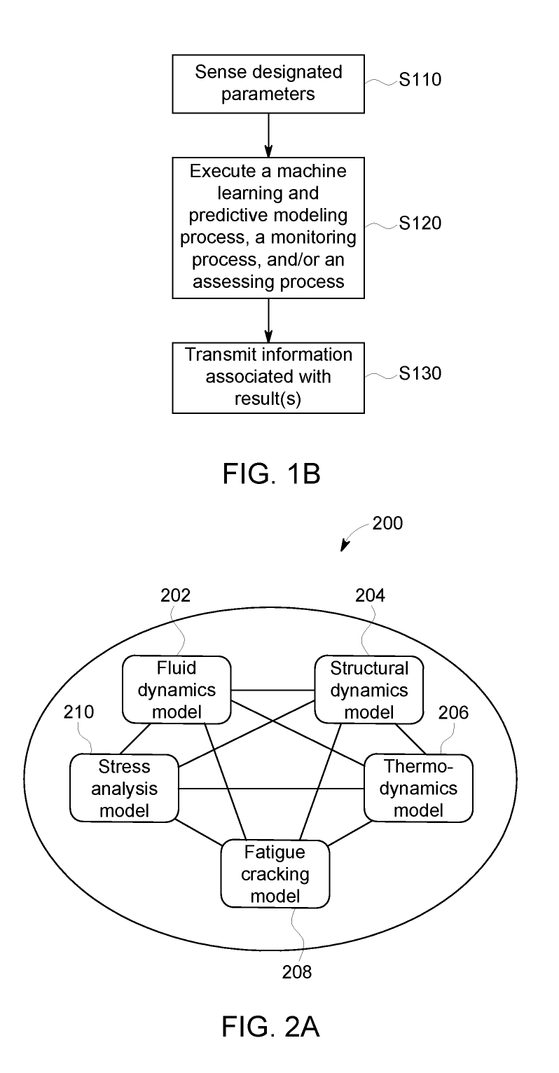

FIG. 1A illustrates a high-level architecture of a system 100 in accordance with some embodiments. The system 100 includes a computer data store 110 that provides information to a digital twin of twinned physical system 150. Data in the data store 110 might include, for example, information about a twinned physical system 120 (or physical asset, such as a jet engine), such as historic engine sensor information about a number of different aircraft engines and prior aircraft flights (e.g., external temperatures, exhaust gas temperatures, engine model numbers, takeoff and landing airports, etc.).

The digital twin of twinned physical system 150 may, according to some embodiments, access the data store 110, and utilize a probabilistic model creation unit to automatically create a predictive model that may be used by a digital twin modeling software and processing platform 160 to generate a prediction and/or result that may be transmitted to various user platforms 170 (such as a Smartphone, tablet computer, laptop computer, and the like), as appropriate (e.g., for display to a user). As used herein, the term “automatically” may refer to, for example, actions that can be performed with little or no human intervention.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The digital twin of twinned physical system 150 may store information into and/or retrieve information from various data sources, such as the computer data store 110 and/or one or more of the user platforms 170. The various data sources may be locally stored or reside remote from the digital twin of twinned physical system 150. Although a single digital twin of twinned physical system 150 is shown in FIG. 1A, any number of such devices may be included. Moreover, various devices described herein might be combined according to embodiments of the present invention. For example, in some embodiments, the digital twin of twinned physical system 150 and one or more data sources might comprise a single apparatus. Thus, in some implementations, the digital twin software of twinned physical system 150 function is performed by a constellation of networked devices or apparatuses, in a distributed processing or cloud-based architecture.

A user may access the system 100 via one of the user platforms 170 (e.g., a personal computer, tablet, or smartphone) to view information about and/or manage a digital twin in accordance with any of the embodiments described herein. According to some embodiments, an interactive interface, such as a graphical user interface (GUI), may permit an operator to define and/or to adjust certain parameters and/or to provide or receive automatically generated recommendations or results.

For example, FIG. 1B illustrates a method that may be performed by some or all of the elements of the system 100 of FIG. 1A. It should be understood that the flow charts described herein do not imply a fixed order to the steps, and embodiments described herein may be practiced in any order that is practicable. It should also be noted that any of the methods described herein may be performed by hardware, software, middleware, and/or any combination of these approaches. For example, a non-transitory, computer-readable storage medium (or non-transitory memory device) may store thereon instructions that when executed by a machine result in performance according to any of the embodiments described herein.

Referring again to FIG. 1B, at S110, one or more sensors may sense one or more designated parameters of a twinned physical system. For at least a selected portion of the twinned physical system, a computer processor may execute at S120 at least one of: (i) a machine learning and predictive modeling process in accordance with the methods disclosed herein, (ii) a monitoring process to monitor a condition of the selected portion of the twinned physical system based at least in part on the sensed values of the one or more designated parameters, and (ii) an assessing process to assess a remaining useful life of the selected portion of the twinned physical system based at least in part on the sensed values of the one or more designated parameters. At S130, information associated with one or more results generated by the computer processor is transmitted via a communication port coupled to the computer processor. Note that, according to some embodiments, the one or more sensors are to sense values of the one or more designated parameters, and the computer processor is to execute the machine learning and predictive modeling, monitoring and/or assessing processes, which may occur even when the twinned physical system is not operating.

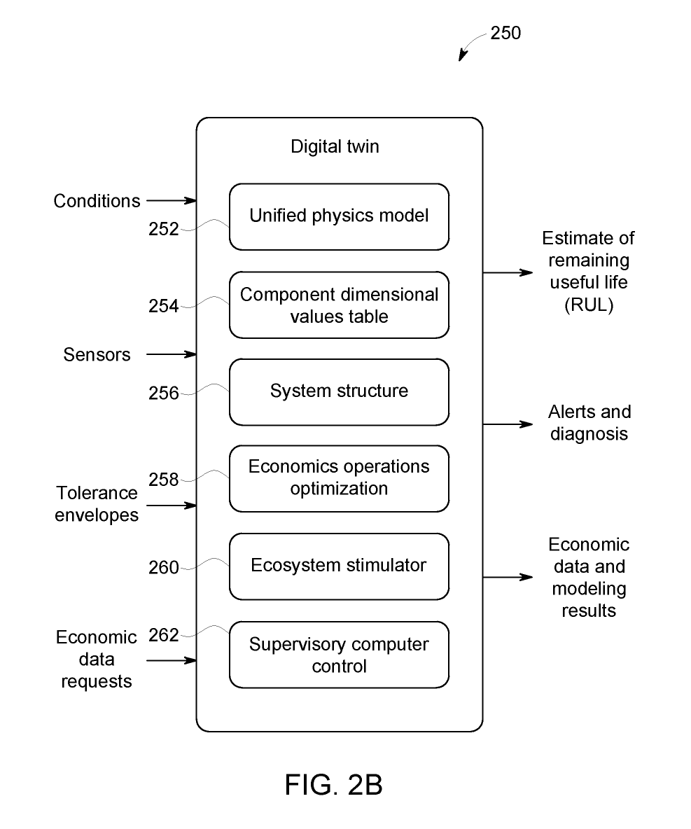

According to some embodiments described herein, a digital twin may thus have at least three functions: performance of machine learning and generating predictive models using parameters of a twinned physical system, monitoring the twinned physical system, and performing prognostics on the twinned physical system. Another function of a digital twin may comprise a limited or total control of the twinned physical system. In one embodiment, a digital twin of a twinned physical system consists of (1) one or more sensors sensing the values of designated parameters of the twinned physical system, and (2) an ultra-realistic computer model of all of the subject system's multiple elements and their interactions under a spectrum of conditions. This may be implemented using a computer model having substantial number of degrees of freedom and may be associated with, as illustrated 200 in FIG. 2A, an integration of a plurality of complex physical models for computational fluid dynamics 202, structural dynamics 204, thermodynamic modeling 206, stress analysis modeling 210, and/or a fatigue cracking model 208. Such an approach may be associated with, for example, a Unified Physics Model (“UPM”).

FIG. 2B illustrates a digital twin 250 including a UPM 252. The digital twin 250 may use algorithms, such as, but not limited to, an Extended Kalman Filter, to compare model predictions with measured data coming from a twinned physical system. The difference between predictions and the actual sensor data, called variances or innovations, may be used to tune internal model parameters such that the digital twin is 250 matched to the physical system. The digital twin's UPM 252 may be constructed such that it can adapt to varying environmental or operating conditions being seen by the actual twinned asset. The underlying physics-based equations may be adapted to reflect the new reality experienced by the physical system.

The digital twin 250 also includes a Component Dimensional Values (“CDV”) table 254 which might comprise a list of all of the physical components of the twinned physical system. Each component may be labeled with a unique identifier, such as an Internet Protocol version 6 (“IPv6”) address. Each component in the CDV table 254 may be associated with, or linked to, the values of its dimensions, the dimensions being the variables most important to the condition of the component. A Product Lifecycle Management (“PLM”) infrastructure, if beneficially utilized, may be internally consistent with CDV table 254 so as to enable lifecycle asset performance states as calculated by the digital twin 250 to be a closed loop model validation enablement for dimensional and performance calculations and assumptions. The number of the component's dimensions and their values may be expanded to accommodate storage and updating of values of exogenous variables discovered during operations of the digital twin.

The digital twin 250 may also include a system structure 256 which specifies the components of the twinned physical system and how the components are connected or interact with each other. The system structure 256 may also specify how the components react to input conditions that include environmental data, operational controls, and/or externally applied forces.

The digital twin 250 might also include an economic operations optimization process 258 that governs the use and consumption of an industrial system to create operational and/or key process outcomes that result in financial returns and risks to those planned returns over an interval of time for the industrial system user and service providers. Similarly, the digital twin 250 might include an ecosystem simulator 260 that may allow all contributors to interact, not just at the physical layer, but virtually as well. Component suppliers, or anyone with expertise, might supply the digital twin models that will operate in the ecosystem and interact in mutually beneficial ways. The digital twin 250 may further include a supervisory computer control 262 that controls the overall function of the digital twin 250 and accepts inputs and produces outputs. The flow of data, data store, calculations, and/or computing required to calculate one or more states and then subsequently use that performance and life state(s) estimation for operations and PLM closed loop design may be orchestrated by the supervisory computer control 262 such that a digital thread connects design, manufacturing, and/or other types of operations.

As used herein, the term “on-operation” may refer to an operational state in which a twinned physical system and the digital twin 250 are both operating. The term “off-operation” may refer to an operational state in which the twinned physical system is not in operation but the digital twin 250 continues to operate. The phrase “black box” may refer to a subsystem that may be comprised by the digital twin 250 for recording and preserving information acquired on-operation of the twinned physical system to be available for analysis off-operation of the twinned physical system. The phrase “tolerance envelope” may refer to the residual, or magnitude, by which a sensor's reading may depart from its predicted value without initiating other action such as an alarm or diagnostic routine. The term “tuning” may refer to an adjustment of the digital twin's software or component values or other parameters. The operational state may be either off-operation or on-operation. The term “mode” may refer to an allowable operational protocol for the digital twin 250 and its twinned physical system. There may be, according to some embodiments, a primary mode associated with a main mission and secondary modes.

Referring again to FIG. 2B, the inputs to the digital twin 250 may include conditions such as environmental data (i.e., weather-related quantities), and operational controls such as requirements for the twinned physical system to achieve specific operations as would be the case for example for aircraft controls. Inputs may also include data from sensors that are placed on and/or within the twinned physical system. A sensor suite embedded within the twinned physical system may provide an information bridge to the digital twin software. Other inputs may include tolerance envelopes (that specify time and magnitude regions that are acceptable regions of differences between actual sensor values and their predictions by the digital twin), maintenance inspection data, manufacturing design data, economic data, and/or hypothetical exogenous data (e.g., weather, fuel costs and defined scenarios such as candidate design, data assignment, and maintenance/or work-scopes).

The outputs from the digital twin 250 may include a continually updated estimate of the twinned physical system's Remaining Useful Life (“RUL”). The RUL estimate at time=t is for input conditions up through time=t−τ where τ is the digital twin's update interval. The outputs might further include a continually updated estimate of the twinned physical system's efficiency. For example, the BTU/kWHr or Thrust/specific fuel consumption estimate at time=t is for input conditions up through time=t−τ where τ is the digital twin's update interval. Other outputs from the digital twin 250 may include alerts of possible twinned physical system component malfunctions, and the results of the digital twin's diagnostic efforts, and/or performance estimates of key components within the twinned physical system. In some embodiments, a Graphical Interface Engine (“GIE”) (not shown) may be included in a digital twin. The GIE may let an operator select components of the twinned physical system that are specified in the digital twin's system structure and display renderings of the selected components scaled to fit a monitor's display. For example, pictures, especially moving pictures, may be provided that may instill greater insight for a technical observer as compared to what can be determined from presentations of arrays or a time series of numerical values. A structural engineer or a thermodynamics expert, for example, may often gain a deep insight into problems by observing the nature of component flexions or the development of heat gradients across components and their connections to other components. The GIE may also animate the renderings as the digital twin simulates a mission and display the renderings with an overlaid color (or texture) map whose colors (or textures) correspond to ranges of selected variables comprising flexing displacement, stress, strain, temperature, etc.

In another example, with the digital twin 250, an operator might be able to see how key sections of a gas turbine are degrading in performance. Such information and/or data might be an important consideration for maintenance scheduling, optimal control, and/or other goals. According to some embodiments, information may be recorded and preserved in a black box utilized to respect on-operation information of the twinned physical system for analysis off-operation of the twinned physical system.

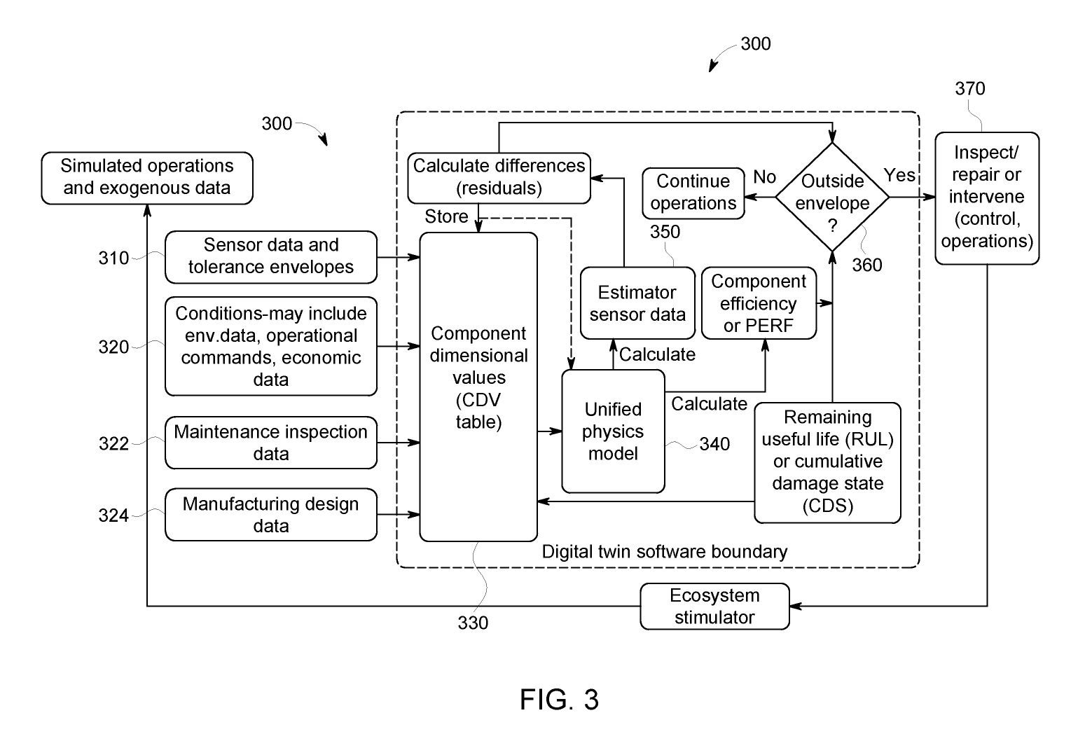

FIG. 3 illustrates an example 300 of a digital twin's functions according to some embodiments. Sensor data and tolerance envelopes 310 from one or more sensors and conditions data 320, which includes operational commands, environmental data, economic data, etc., are continually entered into the digital twin software. A UPM 340 is driven by CDV table values 330 (which may include maintenance inspection data 322 and/or manufacturing design data 324) and the conditions data 320. The sensor data 310 is compared to the expected sensor values 350 produced by the UPM 340. If differences between the sensor values at time=t and the UPM predictions fall outside of the tolerance envelopes, then a report issues at 360. The report 360 may state the occurrence of the exceeded values and lists all of the components that have been previously identified and/or stored in the system structure of the digital twin. A report 360 recommendation 370 may indicate that the report 360 should be handled in different ways according to whether the digital twin is being examined off-line, at the conclusion of a mission for example, or whether the digital twin is operating on-line as it accompanies its twinned physical system and continually provides an estimate of the RUL (or a Cumulative Damage State (“CDS”)). The CDV table 330 may be updated by the sensor data 310 and conditions data 320 at time=t+τ. The recommendation 370 (e.g., to inspect, repair, and/or intervene in connection with control operations) may be used to determined simulated operations exogenous data via an ecosystem simulator.

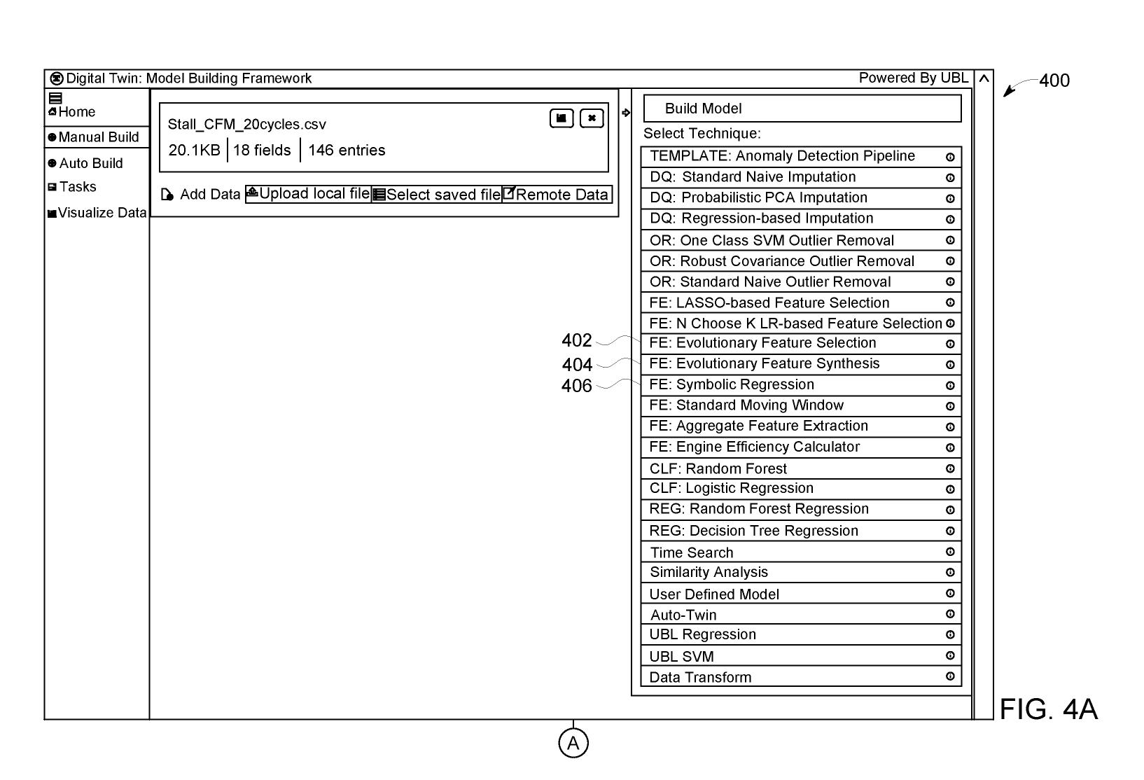

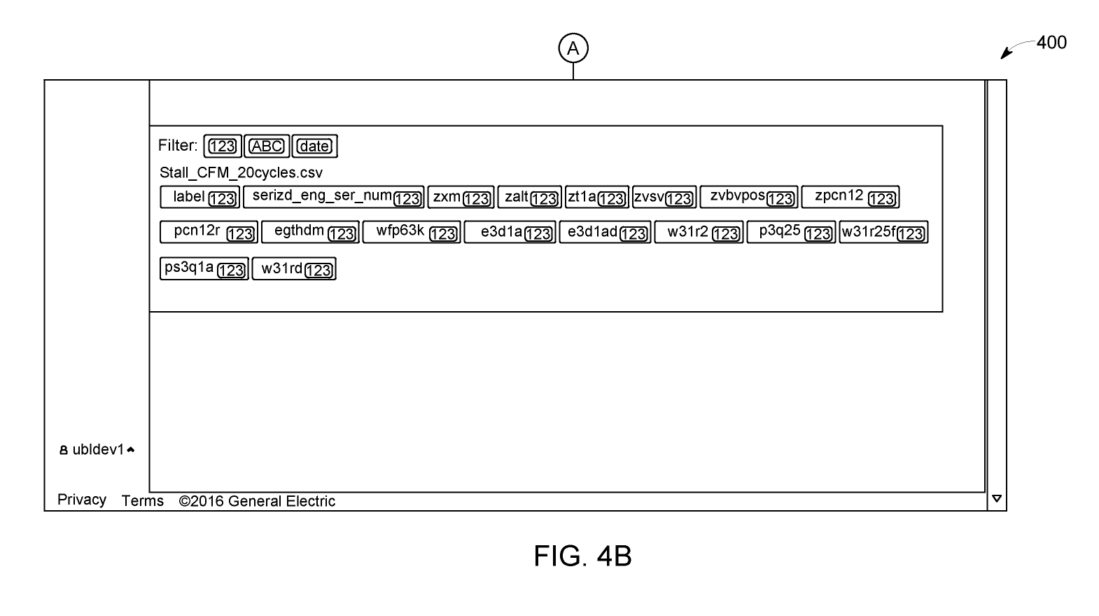

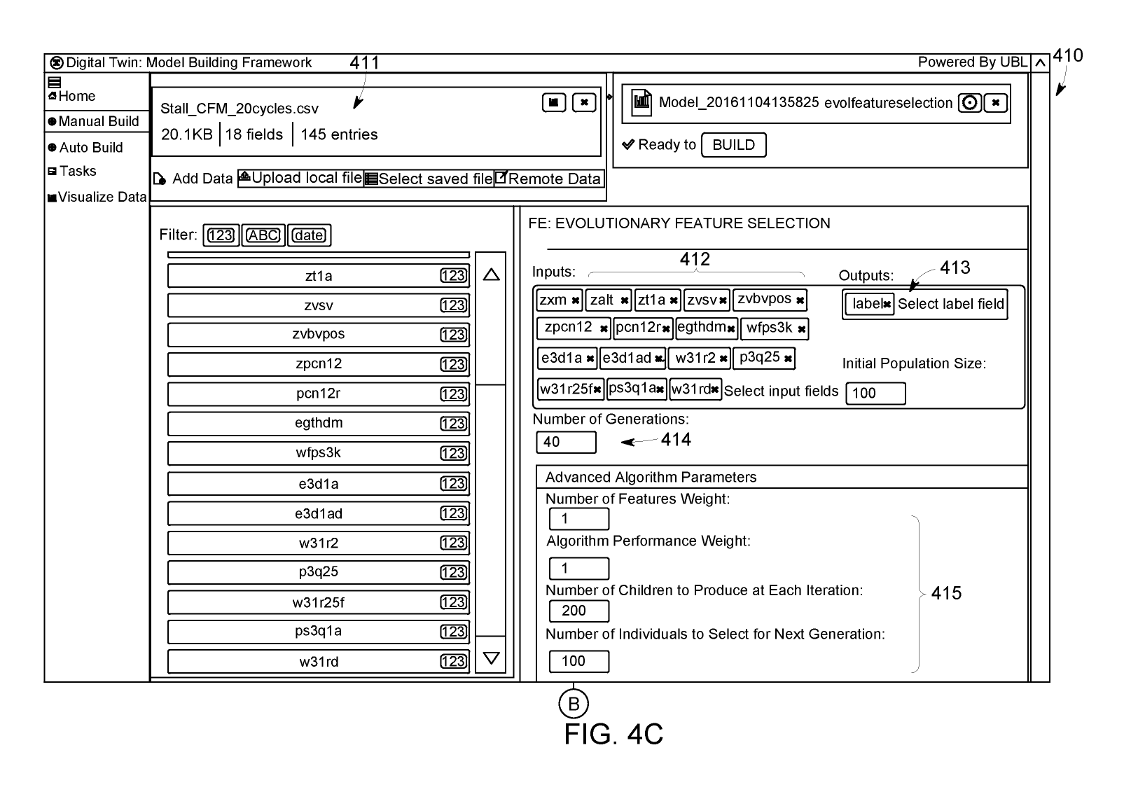

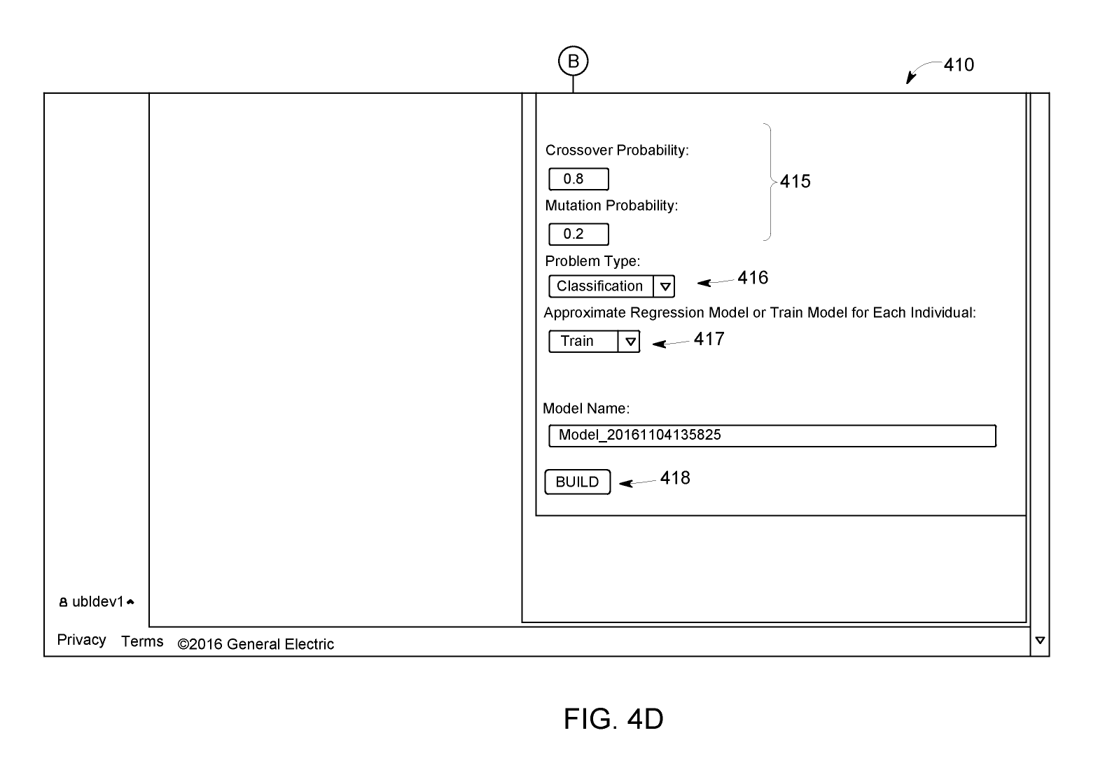

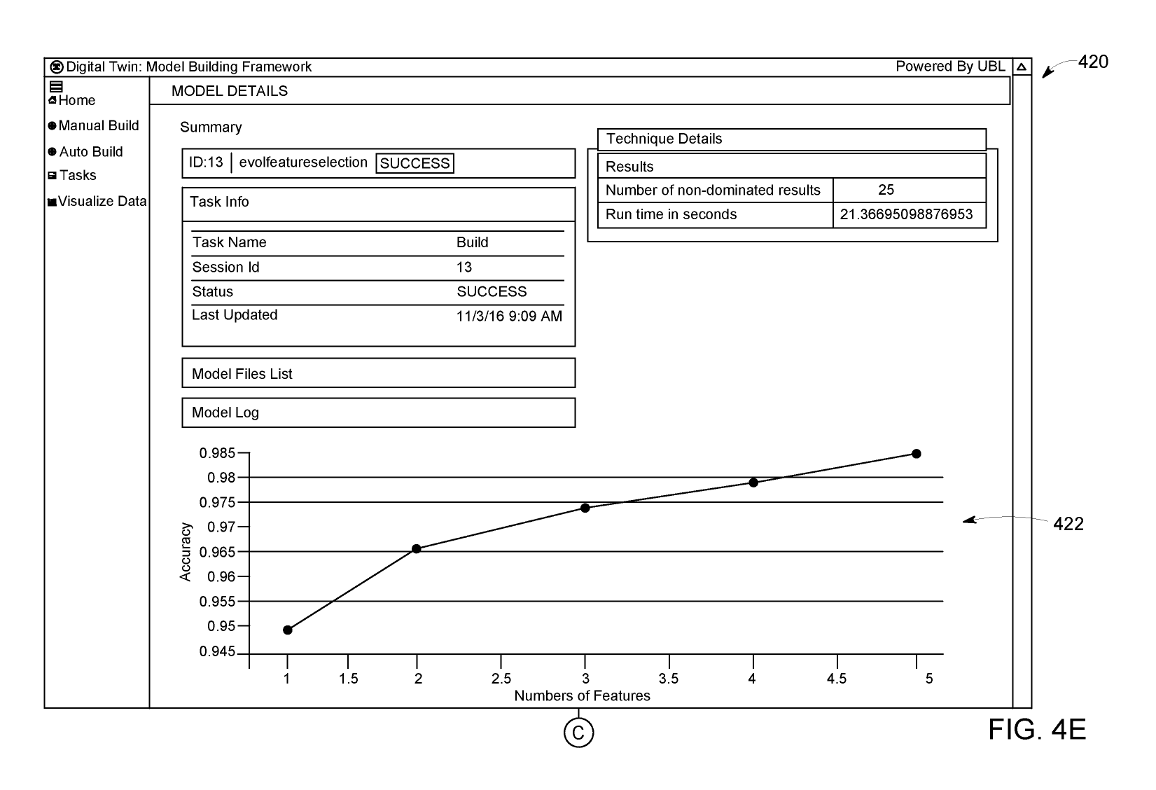

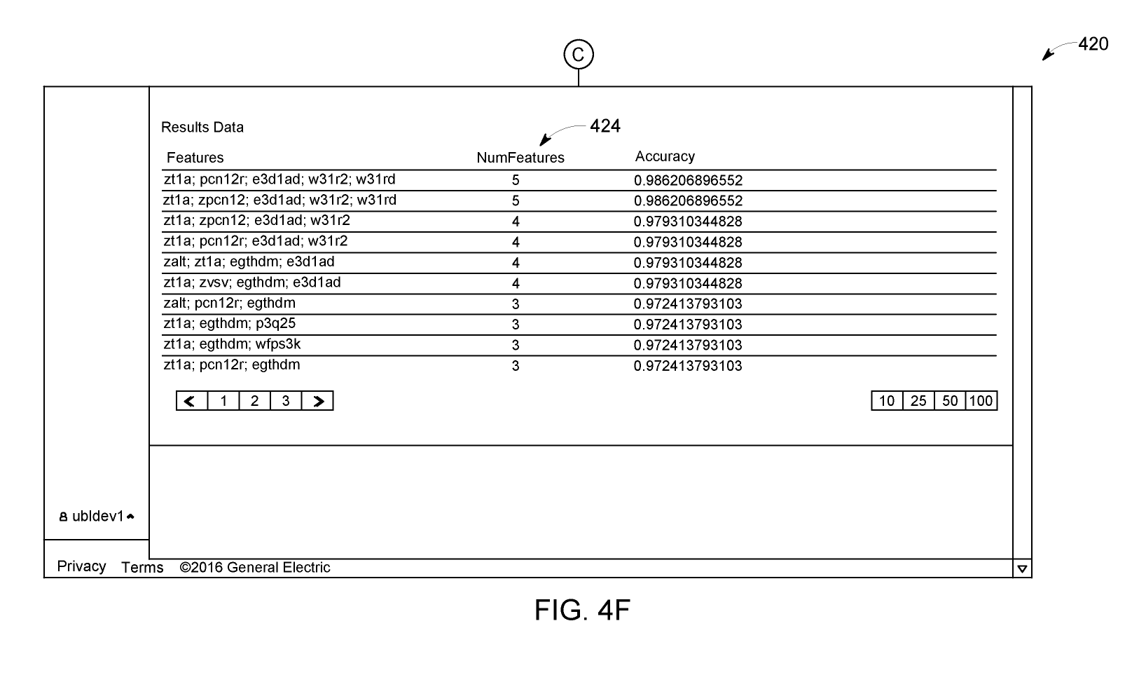

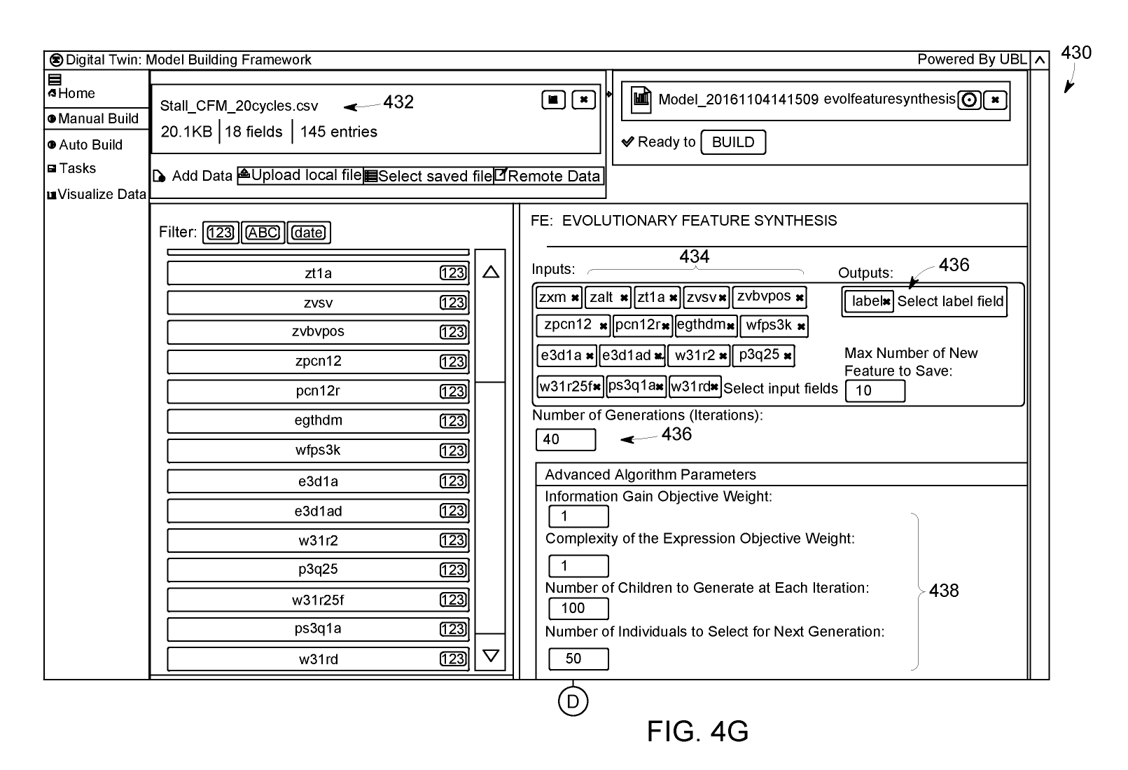

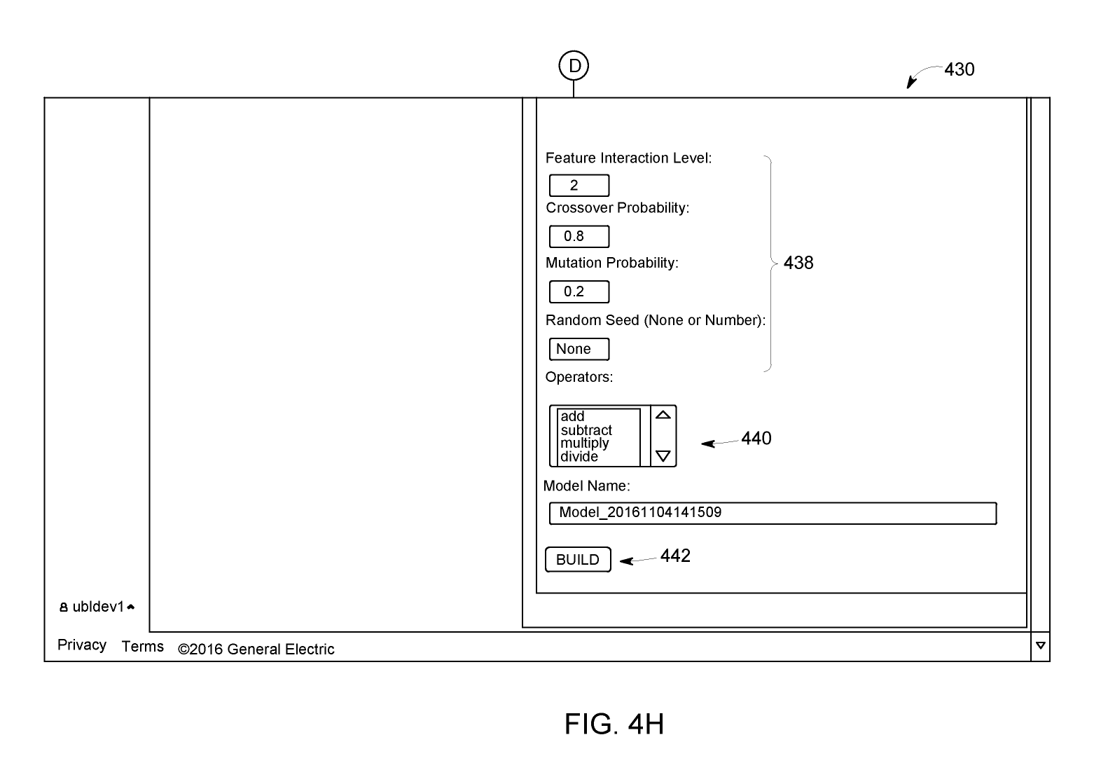

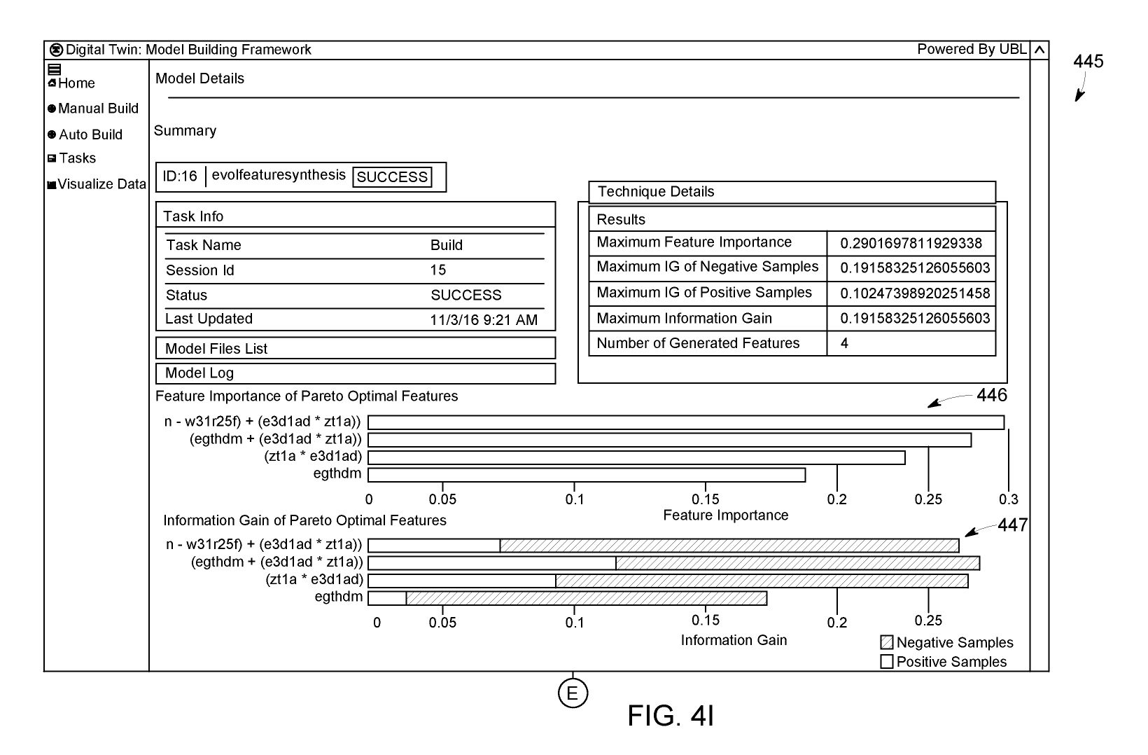

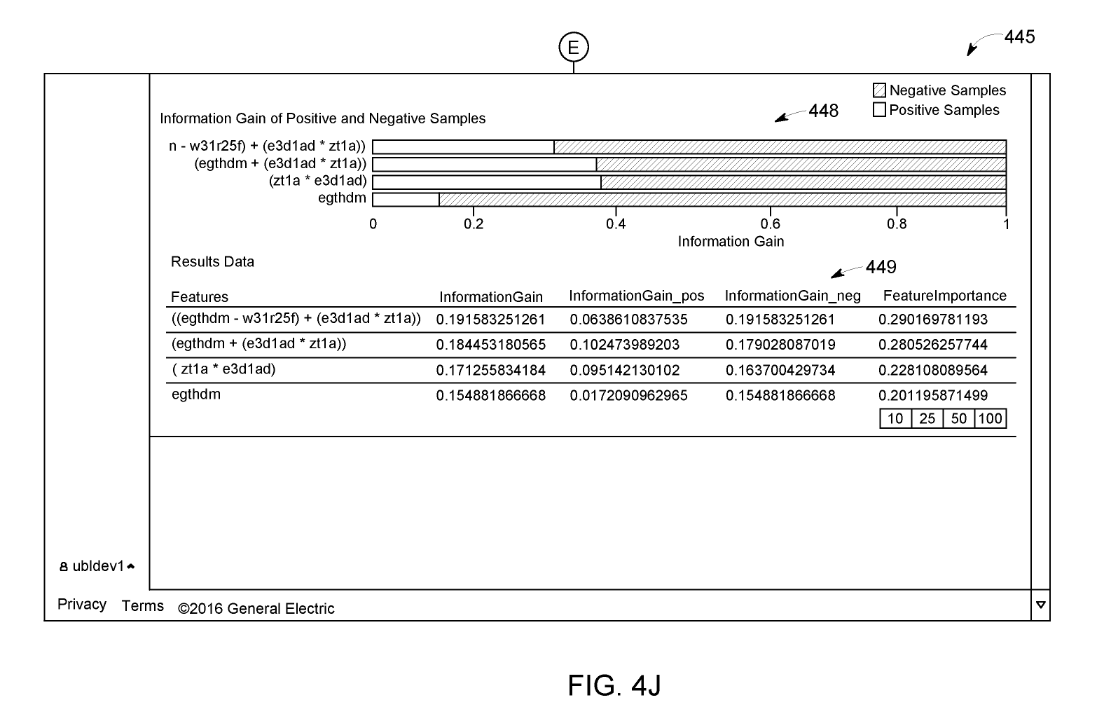

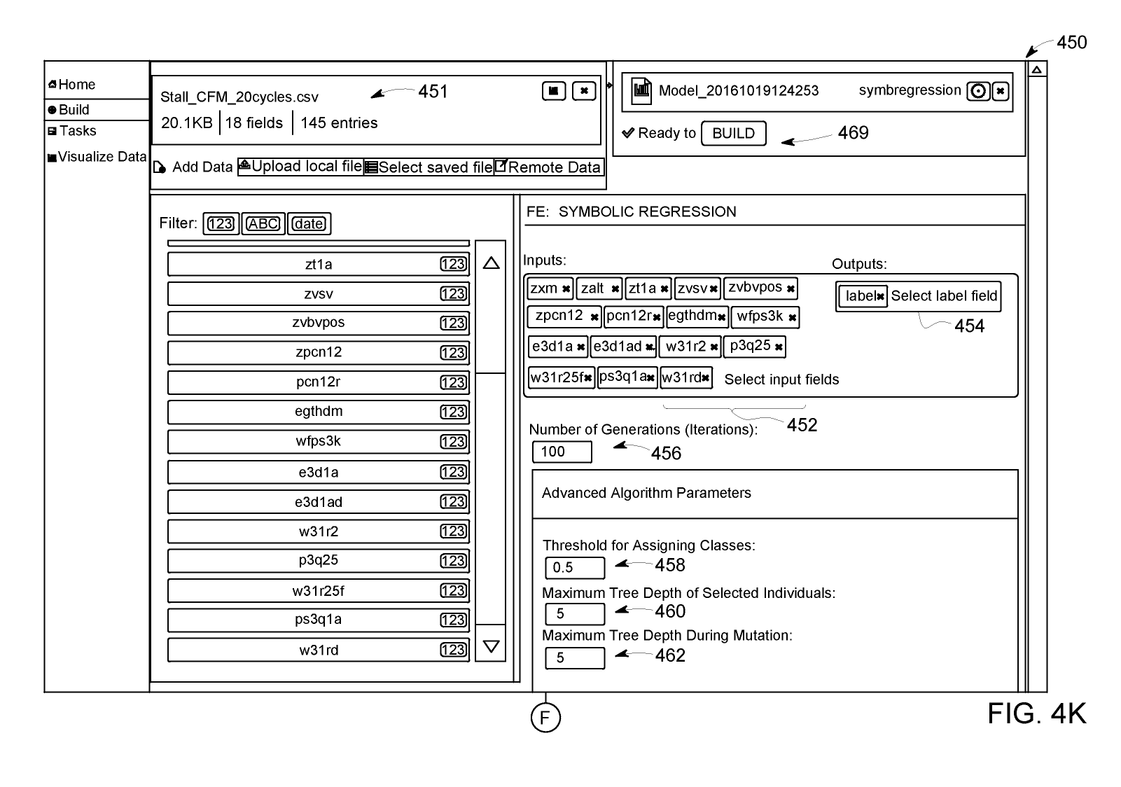

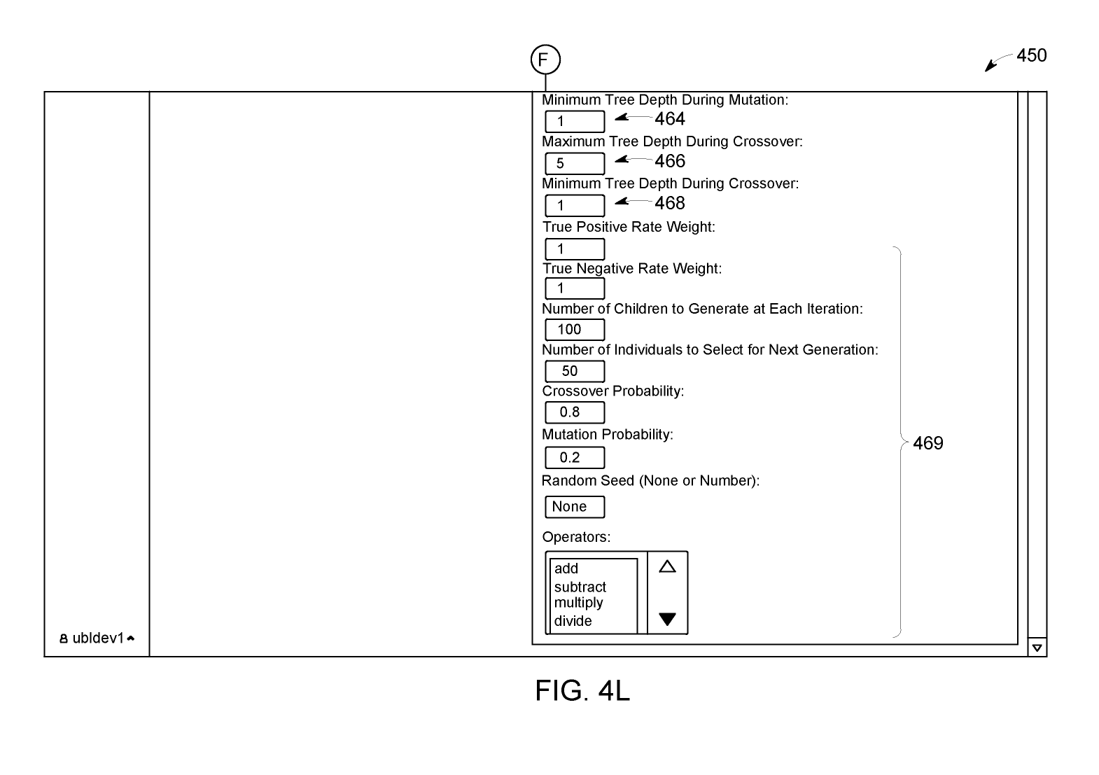

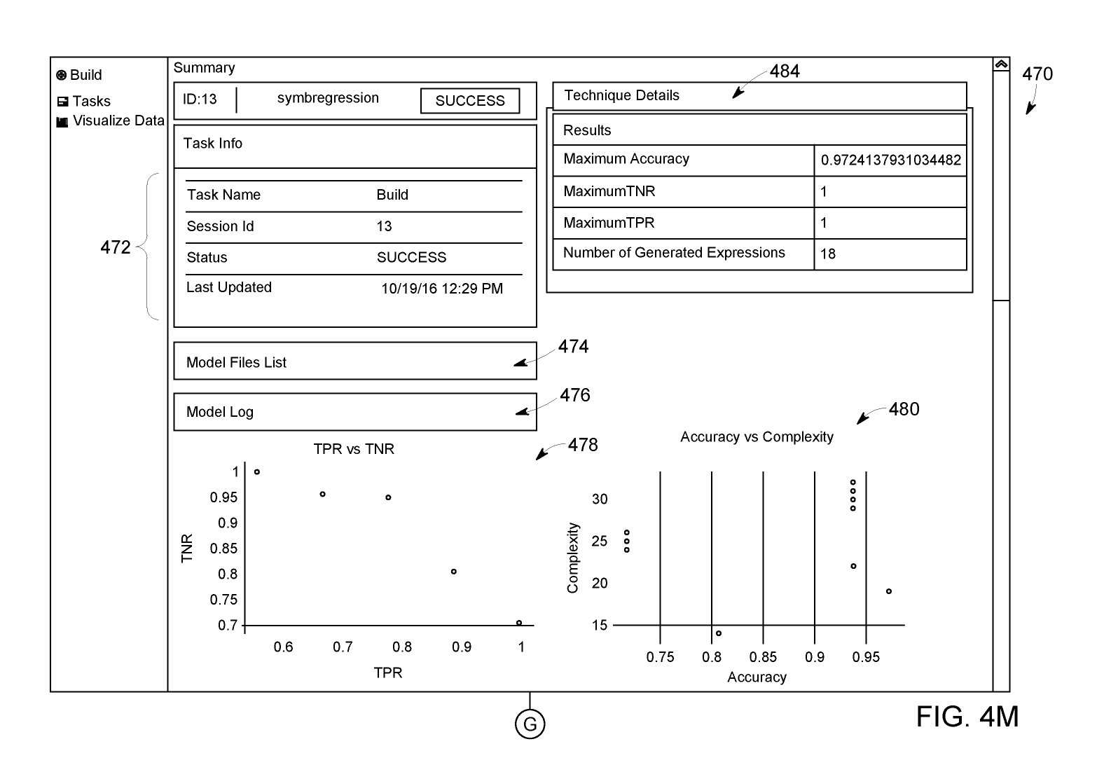

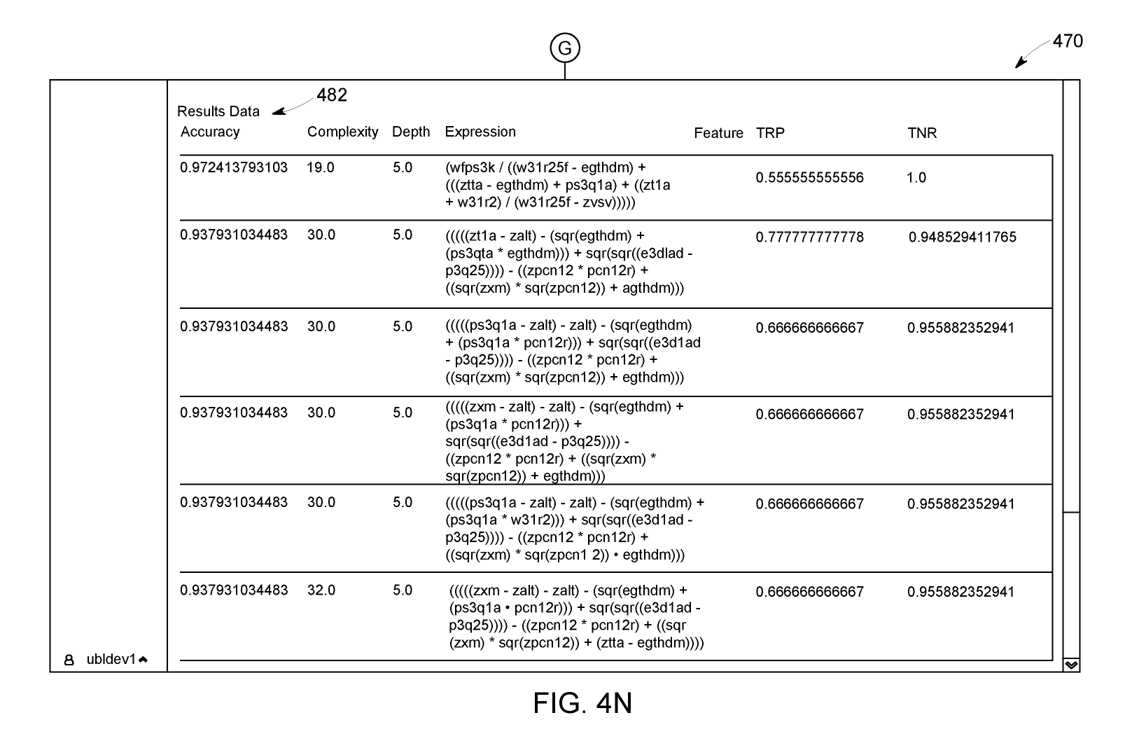

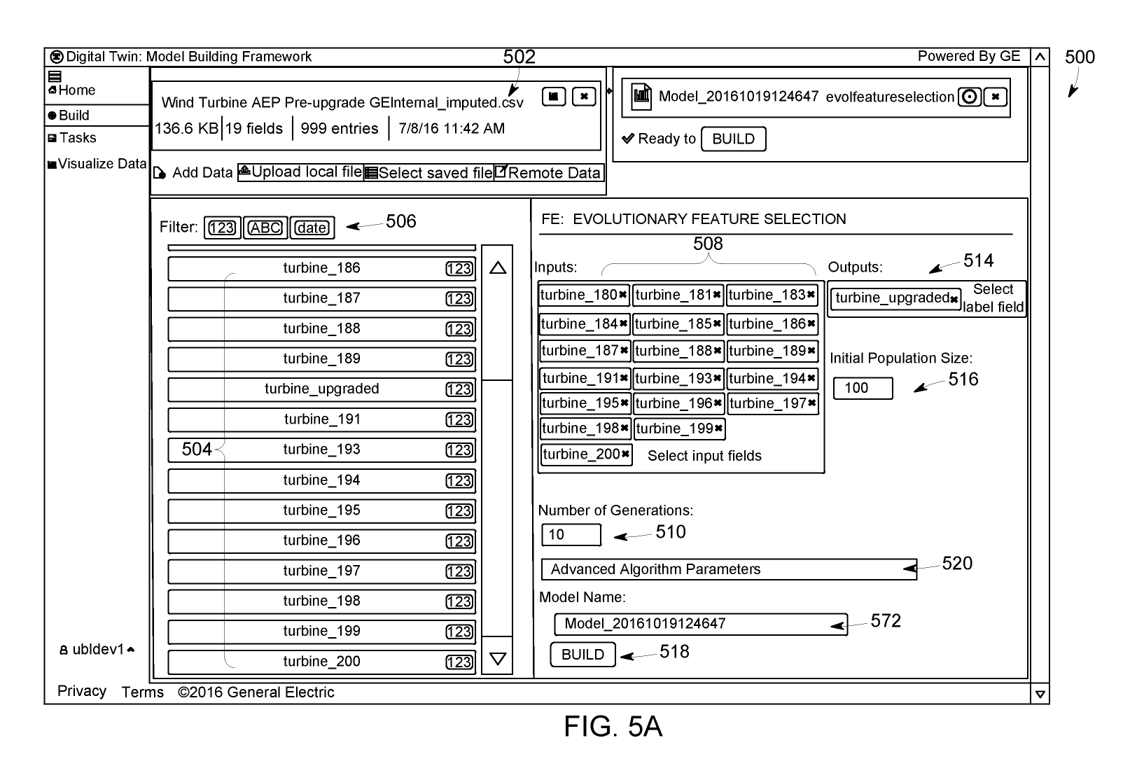

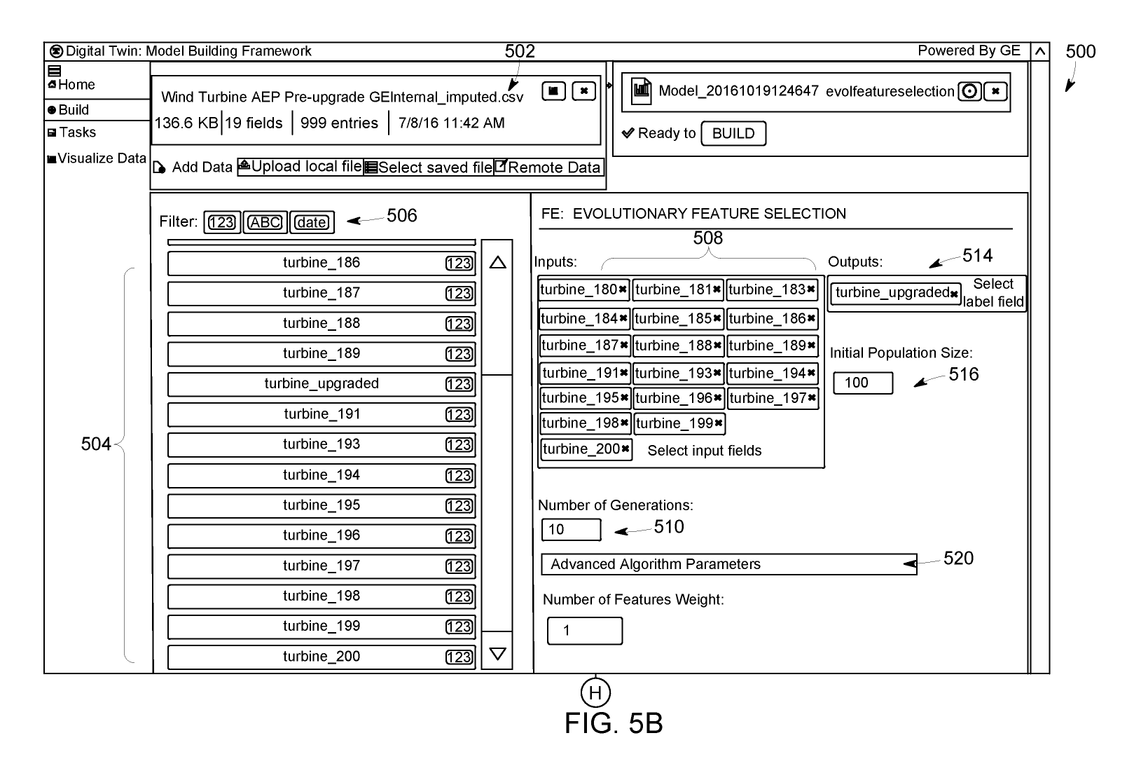

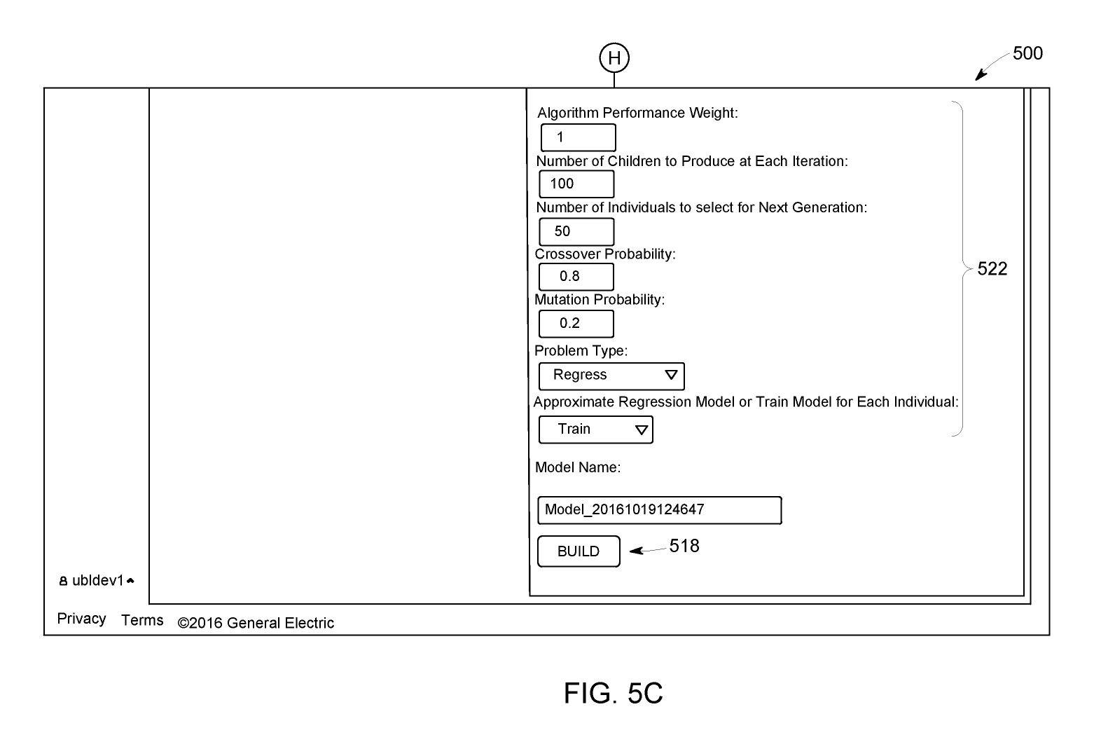

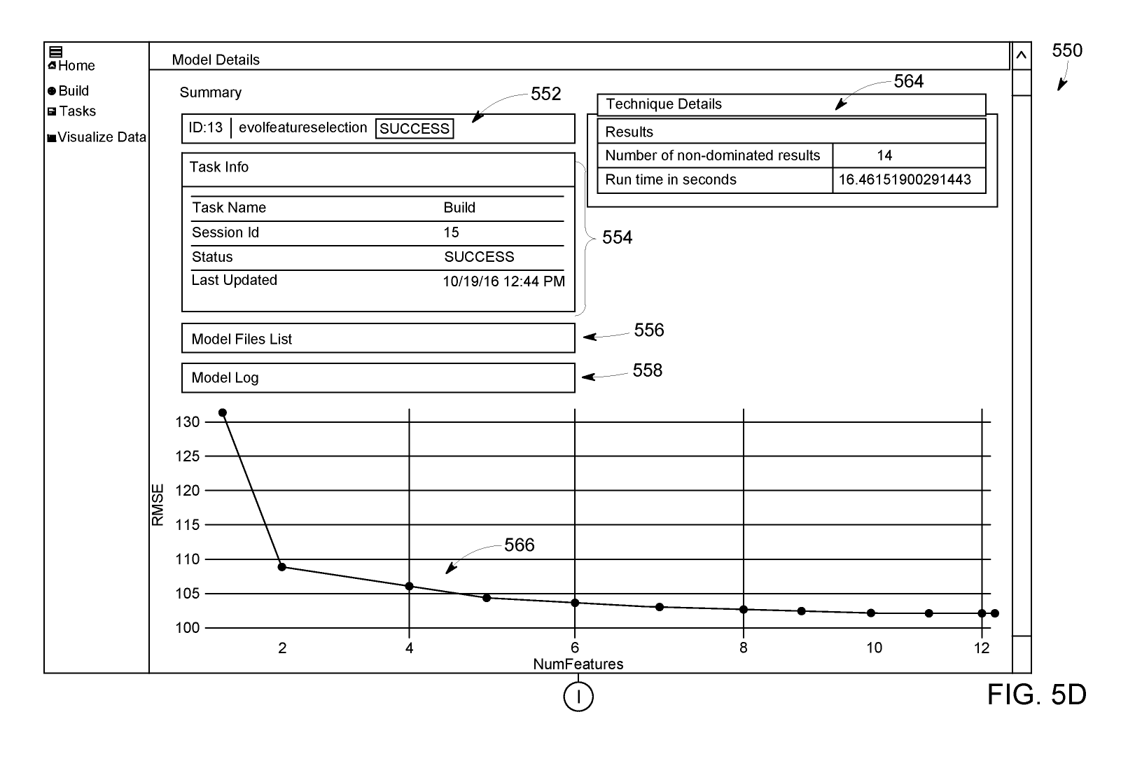

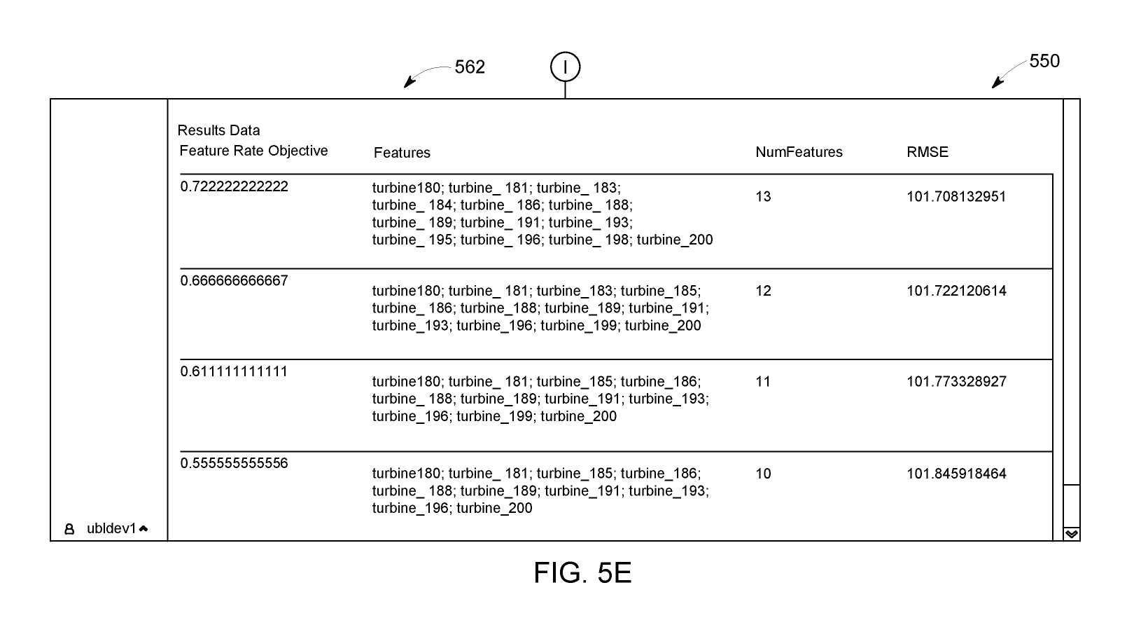

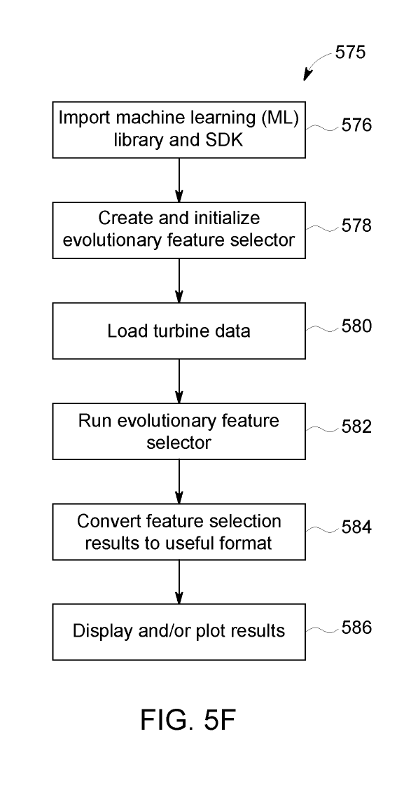

FIGS. 4A-4B form a screen shot of a digital twin (DT) model building framework graphical user interface (GUI) 400 in accordance with some embodiments. It should be understood that, although the screen shots shown in FIGS. 4A-4N and 5A-5E depict graphical user interface (GUI) implementations, other types of user interface(s) could be utilized. As shown, the DT model building framework GUI 400 includes feature engineering (FE) technique selections including evolutionary feature selection 402, evolutionary feature synthesis 404, and symbolic regression 406.

The evolutionary feature selection kernel implements an evolutionary method to select features from a multi-dimensional dataset. A central premise when using a feature selection technique is that the data contains many features that are either redundant or irrelevant, and can thus be removed without incurring much loss of information. The use of fewer features or attributes is desirable because it reduces the complexity of the model, and a simpler model is simpler to understand and explain. In some implementations, the evolutionary feature selection process may also utilize a selection method based on NSGA-II, and the kernel supports classification and regression problems. With regard to classification problems, the evolutionary feature selection kernel supports the two objective functions of increasing accuracy, and of decreasing the number of features. In addition, the goals for the regression problem are to minimize the root-mean-square error (RMSE) and to minimize the number of features. A DT platform user can control the importance of the objectives in both problem types by utilizing weight parameters.

Accordingly, FIGS. 4C-4D from a screen shot of an Evolutionary Feature selection technique GUI 410 of the type that a user of the DT model building platform would utilize to specify one or more parameters for a classification problem according to some embodiments. In this example, multi-dimensional aircraft engine stall data in a CSV format input data file 411 is utilized. The comma-separated values (CSV) file stores tabular data (numbers and text) in plain text, wherein each line of the file is a data record consisting of one or more fields, separated by commas. The user utilizes an input device, such as a computer mouse, to select data, data variables and change parameters as needed. In particular, text field 412 shows the subset of variables users selected that will be utilized by the process, and a label field 413 is also provided to name the output (for identification purposes). In addition, the number of generations 414 is entered, and advanced algorithm parameters 415 provided, such as the Number of Features Weight, the Algorithm Performance Weight, the Number of Children to Produce at Each Iteration, the Number of Individuals to Select for Next Generation, a Crossover Probability, and a Mutation probability. The user also selected a Problem Type 416, which is “classification” here (which may be selected, for example, from a drop-down menu), selected a Train Model for each individual, and then will click on the “Build” button 418 to start the selection process.

FIGS. 4E-4F form a screen shot of an Evolutionary Feature selection technique summary output page 420 according to some embodiments. An output graph 422 is shown that provides data on the number of features versus accuracy, and a table 424 lists the features, number of features and accuracy that was achieved by a classifier that was trained using the features showed in the first column. The user may then review this data and decide whether or not to run another evolutionary feature selection analysis on the engine stall data with one or more different inputs and/or parameters, or use the selected features to train a classification model that could predict engine and/or stall performance.

Referring again to FIGS. 4A-4B, the FE technique of Evolutionary feature synthesis 404 has two objectives: to reduce mathematical expression complexity and to increase information gain of the feature. Accordingly, when this FE technique is selected the user is presented with the Evolutionary Feature Synthesis GUI 430 shown in FIGS. 4G-4H. The Evolutionary feature synthesis GUI 430 is of a type that a user of the DT model building platform would utilize to select data and data variables, and to change parameters as needed. In this example, multi-dimensional aircraft engine stall data in a CSV format input data file 432 is utilized. Once again, the user utilizes an input device, such as a computer mouse, to click on buttons 434 to select one or more input parameters, and utilizes a keyboard to enter a name in the label field 436 to name the output (for identification purposes). In addition, the number of generations 436 is entered, and advanced algorithm parameters 438 are provided, such as the Information Gain Objective Weight, the Complexity of Expressions Objective Weight, the Number of Children to Generate at Each Iteration, the Number of Individuals to Select for Next Generation, a Feature Interaction Level, a Crossover Probability, a Mutation probability, and a Random Seed (none or a number). The user can also make a selection from an Operators field to provide one or more operators for use (the supported operators may include, for example, add, subtract, multiply, divide and the like). A DT platform user uses his or her judgment and/or experience with regard to the physical asset to be modeled when inputting a value for each of the advanced algorithm parameters offered by the Evolutionary Feature Synthesis GUI 430. Once all selections are made, the user clicks on the “Build” button 422 to start the evolutionary feature synthesis process.

FIGS. 4I-4J form a screen shot of an Evolutionary Feature synthesis technique summary output page 445 according to some embodiments. Shown are an output graph of Feature Importance of Pareto Optimal features 446, another output graph of Information Gain of Pareto Optimal features 447, and another output graph of Information Gain of Positive and Negative Samples 448. A Results data table 449 is also provided that lists the features, the information gain data, and positive information gain data. The user may then review this data and decide whether or not to run another evolutionary feature synthesis on the engine stall data with one or more different inputs and/or parameters, or use one of the feature sets to train a regression model that could predict engine performance and/or identify engine stalls.

Referring again to FIGS. 4A-4B, the FE technique of symbolic regression 404 may be utilized by a user of the DT model building framework to synthesize features from a multi-dimensional dataset. Symbolic regression is a type of regression analysis that searches the space of mathematical expressions to find the model that best fits a given dataset, both in terms of accuracy and simplicity. No particular model is provided as a starting point to the algorithm, rather initial expressions are formed by randomly combining mathematical building blocks such as mathematical operators, analytic functions, constants, and state variables which may be specified by a user of the digital twin (DT) platform. New equations can then be formed by recombining previous equations, using genetic programming. Since a specific model is not specified, symbolic regression is not affected by human bias, or unknown gaps in domain knowledge. Instead, symbolic regression attempts to uncover the intrinsic relationships of the dataset, by letting the patterns in the data itself reveal the appropriate models, rather than by imposing a model structure that is deemed mathematically tractable from a human perspective. The fitness functions that drive the evolution of the models take into account not only error metrics to ensure the models accurately predict the data, but also special complexity measures to ensure that the resulting models reveal the underlying structure of the data in a way can be understood by a human, such as a user of the DT platform. This facilitates reasoning and favors the odds of getting insights about the data-generating system.

Accordingly, in some implementations a symbolic regression feature synthesis kernel implements an evolutionary method to synthesize features from a multi-dimensional dataset, and may use a selection method based on NSGA-II (the “Non-dominated Sorting Genetic Algorithm”). NGSA-II is a Multiple Objective Optimization (MOO) algorithm and is an instance of an Evolutionary Algorithm from the field of Evolutionary Computation. The kernel supports classification and regression problem types, and can be utilized to accomplish a first goal of maximizing the true positive rate, and a second goal of maximizing the true negative rate. In some embodiments, the importance of each of these two goals can be controlled by the user specifying weight parameters.

FIGS. 4k-4L form a screen shot 450 of a symbolic regression graphical user interface (GUI) example of the type that a user of a DT platform would utilize to specify one or more parameters to obtain results. Multi-dimensional aircraft engine stall data in a CSV format input data file 451 is again being utilized. An example of output information that may be generated concerns an indication of the true positive rate (TPR) versus the true negative rate (TNR), and accuracy versus complexity. In particular, text box 452 is provided for the user to select one or more input parameters, and a label field 454 is also provided to name the output (for identification purposes). In some embodiments, the advanced algorithm parameter input fields include, but are not limited to, a Number of Generations (Iterations) field 456 (which is required) wherein a user has entered 100 in the present example; a Threshold for Assigning Classes field 458; a Maximum Tree Depth of Selected Individuals field 460 wherein a maximum tree depth of the mathematical expression for qualified individuals can be entered; a Maximum Tree Depth During Mutation field 462, wherein the maximum tree depth of the mathematical expression during mutation operation can be entered; a Minimum Tree Depth During Mutation field 464, wherein a minimum tree depth of the mathematical expression during mutation operation can be entered; a Maximum Tree Depth During Crossover field 466, wherein the maximum tree depth of the mathematical expression during crossover operation can be entered; and a minimum Tree Depth During Crossover field 468, wherein a minimum tree depth of the mathematical expression during crossover operation can be entered. Other advanced algorithm parameters 469 may include, but are not limited to, a True Positive Rate Weight field indicating the measure of importance of TPR objective; a True Negative Rate Weight field to indicate the measure of importance of TNR objective; a Number of Children to Produce at Each Iteration field, to indicate the number of children to produce at each generation; a Number of Individuals to Select for Next Generation field, to indicate the number of individuals to select for the next generation; a Crossover Probability field for indicating the probability that an offspring is produced by crossover; a Mutation Probability field for providing the probability that an offspring is produced by mutation, a Random Seed field (None or Number) to provide a random seed for reproducibility and testing; and an Operators field to provide a set of operators to use (the supported operators may include, for example, add, subtract, multiply, divide, square root, negative, sine, cosine, logarithm, and the like). A DT platform user uses his or her judgment and/or experience with regard to the physical asset to be modeled when inputting a value for each of the input parameters provided by the symbolic regression GUI. After entering a value for the various input parameters, the user then selects the build radio button 469 to run the symbolic regression program.

FIG. 4M-4N form a screen shot of a summary output page 470 illustrating the types of output information provided to a user of a DT platform running the symbolic regression process via the parameters selected using the symbolic regression GUI 450 of FIGS. 4K-4L. A task information field 472 may include the task name, a session identifier, a status (for example, “success” to indicate a successful run), and a “last updated” indication. A model files list 474 can be viewed (if selected), and a model log graphical representation field 476 is shown in a selected state with a “TPR v. TNR” graph 478 along with an “Accuracy vs. Complexity” graph 480 generated for the user. Results data 482 is found near the bottom of the screen, an “Technique Details” summary 484 is also shown. The DT platform user can read the results shown in the summary output page 470, and then decide whether or not to run another symbolic regression analysis on the aircraft engine stall data, or use the generated features to train a classification model to be used in predicting the aircraft engine's stall issues.

FIG. 5A is a screen shot of another example of a digital twin (DT) model building framework graphical user interface (GUI) 500 for an evolutionary feature selection kernel operable to select evolutionary features associated with a wind turbine, of the type that a DT platform user would utilize to specify one or more input parameters in order to obtain predictive modeling results. In this example, a wind turbine AEP pre-upgrade CSV input data file 502 is utilized, which includes data for multiple wind turbines in a list 504. In particular, the DT platform user can apply one or more filters 506 to one or more of the wind turbine data files 504, and select inputs 508, provide a number of generations in field 510, provide a model name 512, designate outputs in field 514, and specify an initial population size 516. Once all inputs are selected and/or information provided, the user selects the “Build” radio button 518 to run the evolutionary features process. However, before running the evolutionary features process, the DT platform user select the “Advanced Algorithm Parameters” section 520 to reveal a plurality of parameters 522 as shown in FIGS. 5B-5C, which advance algorithm parameters may be input and/or specified by the user. In particular, in some embodiments the user can specify an Initial Population Size, which is the size of the initial population of individuals; a Number of Generations, which is the number of generations; a Number of Individuals to Select for Next Generation, which is the number of individuals to select for the next generation; a Number of Children to Produce at Each Iteration, which is the number of children to produce at each generation; a Crossover Probability, which is the probability that an offspring is produced by crossover; a Mutation Probability, which is the probability that an offspring is produced by mutation; a Problem Type, which could be a classification or regression problem type; a Number of Features Weight, which is the significance of number of features objective; an Algorithm Performance Weight, which is the significance of accuracy or RMSE objective; and/or an Approximate Regression Model or Train Model For Each Individual, which is a flag that determines whether training of a regression model will be performed for each individual or an approximation algorithm will be applied.

Accordingly, after providing one or more of the advanced algorithm parameters 522, the user selects the “Build” button 518 so that the process generates the Summary page 550 shown in FIGS. 5D-5E for presentation to the DT platform user. In particular, an indication of success 552 is shown along with task information 554, a model files list 556 (which in this example has not been expanded), a model log 558 (which also has not been expanded) and a graphical representation 560 of the RMSE to the number of features. Also shown is a list of results data 562, and technique details 564. The DT platform user can thus view the results as shown, and then decide whether or not to run another evolutionary feature selection analysis on the wind turbine data with one or more different parameters, or use the selected features to train a regression model that would predict wind turbine performance.

FIG. 5F is a flowchart 575 illustrating an example of an evolutionary feature selection process operable to select evolutionary features associated with a wind turbine in accordance with the disclosure. A user first instructs a DT processor of a DT platform to import 576 a machine language library (ML library) and software tools (which may be provided as a software development kit (SDK)) through use of a DT platform GUI of the type shown in FIG. 5A. The DT processor then creates and initializes 578 an evolutionary feature selector which allows the user to select one or more inputs and advanced algorithm parameters. Next, the DT processor loads 580 turbine data of a plurality of turbines, runs 582 the evolutionary feature selector process, converts 584 feature selection results into a useful format, and then displays 586 results, for example as a tabular and/or graphical plot of the data. In some embodiments, the DT processor may transmit the results data for display, for example, on a user platform 170 (see FIG. 1A), such as a mobile device, of a user of the DT modeling platform.

During a symbolic regression process individuals are evaluated at each iteration to select the individuals with the highest true positive rate and true negative rate to the next generation. The true positive rate and the true negative rate are calculated by applying a model trained using this individual's features to a test dataset and calculating how many true positives and true negatives the model predicted. The process has two ways of evaluating an individual: using approximation or building (training) a logistic regression model for every single individual. For approximation one model is built at the beginning of the process, thus reducing computing time. For an exact method, a model is trained for each individual that was created during the evolutionary process. In some embodiments, if a problem type is regression and an approximation option was selected by the DT model building framework user, then the regression model using all training data and all variables in the data set is trained once, at the beginning of the evolutionary process. When it is time in the process to evaluate an individual, by applying the logistic regression model and calculating true positive and true negative rates and comparing the rates to the rest of the individuals in the population the model that was trained at the beginning of the process is used to evaluate this individual. To be able to use the model that was trained using all variables to evaluate an individual with only a subset of variables that the individual has, the evaluation data is modified by setting the data of missing variables to zeros. If a problem type is regression and the DT model building framework user selected the train option, then every time an individual needs to be evaluated by the algorithm, a new regression model is trained using only a subset of the variables of this individual, and this model is used to evaluate the individual. In each of these cases the evaluation is done by applying the trained model to the individual. This produces prediction values which are then compared to true values, and the true positive rate and the true negative rate are calculated based on the difference between the predicted values and the true values.

In some embodiments, an evolutionary feature synthesis algorithm is provided that uses evolutionary methods to generate new features from a multi-dimensional dataset. The evolutionary search is guided by the features' information gain, which is a metric that measures usefulness of a feature (wherein the higher the information gain the better the feature is), and the complexity of the expression. The information gain is calculated using entropy-based discretization, and the objectives are to maximize the information gain and to minimize the complexity of the expression. The importance of the objectives can be controlled by a DT platform user via input of a magnitude of the weight parameters. The algorithm uses an evolutionary method, and it uses a selection method based on NSGA-II. In addition to the information gain ranking, the evolutionary feature synthesis algorithm produces an entropy-based metric of each feature for positive and negative samples, as well as a feature importance metric for all Pareto Front optimal features. In some implementations, the evolutionary feature synthesis algorithm supports only classification problem types. In addition, in some embodiments, the evolutionary feature synthesis algorithm supports only numerical datasets with binary labels, where negative labels have to be zeros and positive labels can be any non-zero values. In some embodiments, the input parameters may include, but not be limited to a Number of Generations (iterations) which is the number of generations to run; a Number of Individuals to Select for Next Generation, which is the number of individuals to select for next generation; a Number of Children to Generate at Each Iteration, which is the number of children to produce at each generation; a Crossover Probability, which is the probability that an offspring is produced by crossover; a Mutation Probability, which is the probability that an offspring is produced by mutation; an Information Gain Objective Weight, which is the importance measure for the information gain objective; a Complexity of the Expression Objective Weight, which is a measure of importance for the complexity of the expression objective; a Feature Interaction Level, which is the level of feature interaction (depth of max SR tree); a Maximum Number of New Features to Save, which is the maximum number of features to save to file; a Random Seed (None or a Number), which random seed is provided for reproducibility and testing; and a set of operators, such as add, subtract, multiply, divide, square root, negative, cosine, sine, log and the like (wherein a user may input a value of “all” which will select all of the supported operators).

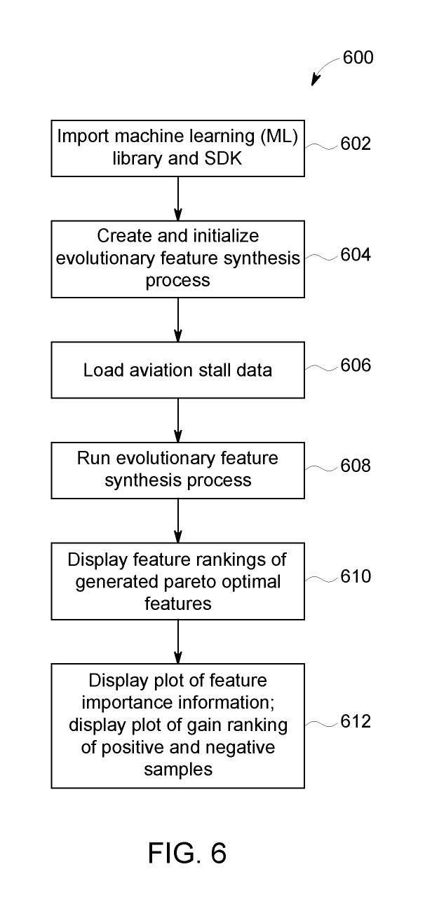

FIG. 6 is a flowchart illustrating an example of an evolutionary feature synthesis process 600 operable to generate new features from a multi-dimensional dataset associated with an aviation stall problem (for example, related to an aircraft engine) in accordance with the disclosure. A user first instructs a DT processor of a DT platform to import 602 a machine language library (ML library) and a software development kit (SDK) through use of a DT platform GUI of the type shown in FIG. 5A. The DT processor then creates and initializes 604 the evolutionary feature synthesis process which allows the user to select one or more input parameters. Next, the DT processor loads 606 aviation stall data of a plurality of aviation engines, runs 608 the evolutionary feature synthesis process, and then then displays 610 feature rankings of generated Pareto optimal features for the DT platform user. Lastly, the DT processor displays 612 a plot of feature importance information of Pareto optimal features, and displays a plot of gain ranking of positive and negative samples. In some embodiments, the DT processor may transmit the feature rankings of generated Pareto optimal features to a user platform 170 (see FIG. 1A), such as a mobile device (i.e., a Smartphone), for display to the user of the DT modeling platform.

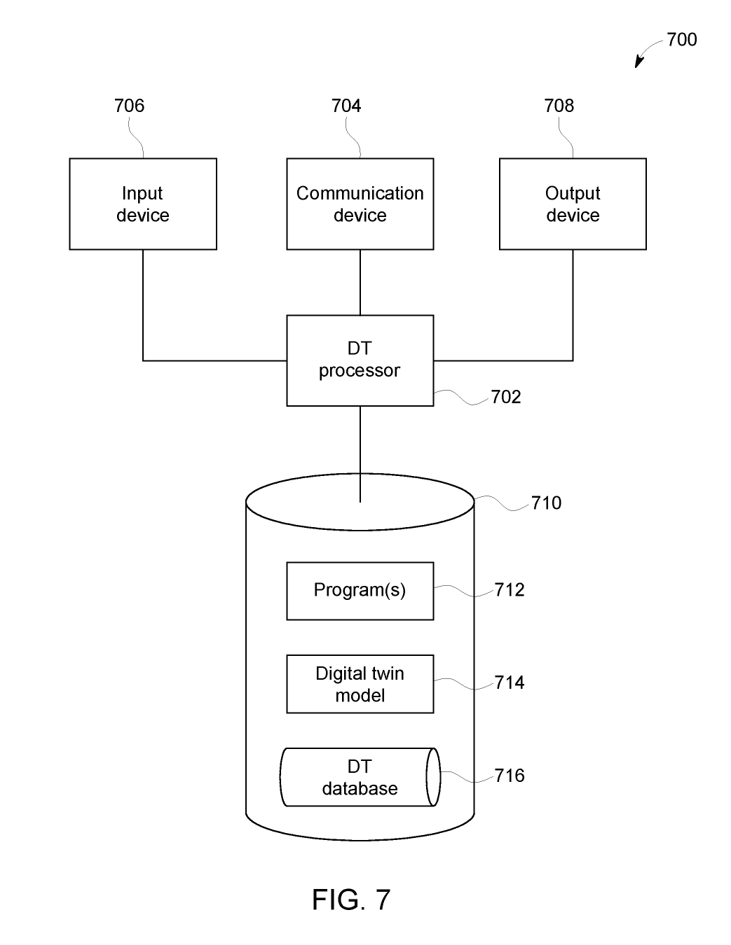

The embodiments described herein may be implemented using any number of different hardware configurations. For example, FIG. 7 is block diagram of a digital twin platform 700 that may be, for example, associated with the system 100 of FIG. 1. The digital twin platform 700 comprises a digital twin (DT) processor 702, which may be one or more commercially available Central Processing Units (“CPUs”) in the form of one-chip microprocessors (or may be constituted of one or more specially designed processor(s)), coupled to a communication device 704 configured to communicate via a communication network (not shown in FIG. 7). The communication device 704 may be used to communicate, for example, with one or more remote user platforms, digital twins, computations associates, and the like. The digital twin platform 700 further includes an input device 706 (e.g., a computer mouse and/or keyboard to input adaptive and/or predictive modeling information) and/an output device 708 (e.g., a computer monitor (which may be a touch screen) to render displays, transmit recommendations, and/or create reports). According to some embodiments, a mobile device (such as a Smartphone) and/or personal computer may be used to exchange information with the DT platform 700.

The DT processor 702 also communicates with a storage device 710. The storage device 710 may comprise any appropriate information storage device, including combinations of magnetic storage devices (e.g., a hard disk drive), optical storage devices, mobile telephones, and/or semiconductor memory devices. The storage device 710 stores a program 712 and/or a probabilistic model 714 for controlling the DT processor 702. The DT processor 702 performs instructions of the programs 712, 714, and thereby operates in accordance with any of the embodiments described herein. For example, the DT processor 702 may receive data and utilize machine learning techniques to generate predictive models concerning one or more operating aspects and/or components associated with a twinned physical system. The DT processor 702 may also, for at least a selected portion of the twinned physical system, monitor a condition of the selected portion of the twinned physical system and/or assess a remaining useful life of the selected portion based at least in part on the sensed values of the one or more designated parameters. The DT processor 702 may transmit information associated with a result generated by the computer processor. Note that the one or more sensors may sense values of the one or more designated parameters, and the DT processor 702 may perform the monitoring and/or assessing, even when the twinned physical system is not operating.

The programs 712, 714 may be stored in a compressed, uncompiled and/or encrypted format. The programs 712, 714 may furthermore include other program elements, such as an operating system, clipboard application, a database management system, and/or device drivers used by the DT processor 702 to interface with peripheral devices.

As used herein, information may be “received” by or “transmitted” to, for example: (i) the digital twin platform 700 from another device; or (ii) a software application or module within the digital twin platform 700 from another software application, module, or any other source.

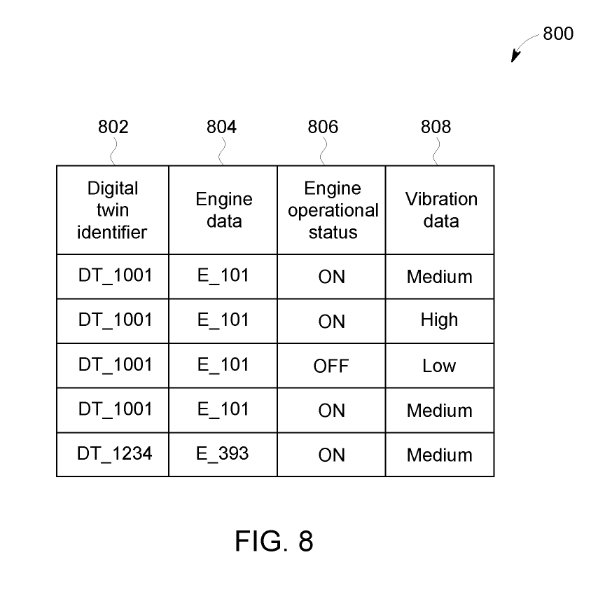

In some embodiments (such as the one shown in FIG. 7), the storage device 710 further stores a digital twin database 716. An example of a database that may be used in connection with the digital twin platform 700 will now be described in detail with respect to FIG. 8. Note that the database described herein is only one example, and additional and/or different information may be stored therein. Moreover, various databases might be split or combined in accordance with any of the embodiments described herein.

Referring to FIG. 8, a data table 800 is shown that represents the digital twin database 716 that may be stored at the digital twin platform 700 according to some embodiments. The data table 800 may include, for example, entries identifying sensor measurement associated with a digital twin of a twinned physical system. The data table may also define fields 802, 804, 806, 808 for each of the entries. The fields 802, 804, 806, 808 may, according to some embodiments, specify: a digital twin identifier 802, engine data 804, engine operational status 806, and vibration data 808. The digital twin database 716 may be created and updated, for example, when a digital twin is created, sensors report values, operating conditions change, and the like.

The digital twin identifier 802 may be, for example, a unique alphanumeric code identifying a digital twin of a twinned physical system. The engine data 804 might identify a twinned physical engine identifier, a type of engine, an engine model, etc. The engine operational status 806 might indicate, for example, that the twinned physical engine state is “on” (operation) or “off” (not operational). The vibration data 808 might indicate data that is collected by sensors and that is processed by the digital twin. Note that vibration data 808 is collected and processed even when the twinned physical system is “off” (as reflected by the third entry in the database 716).

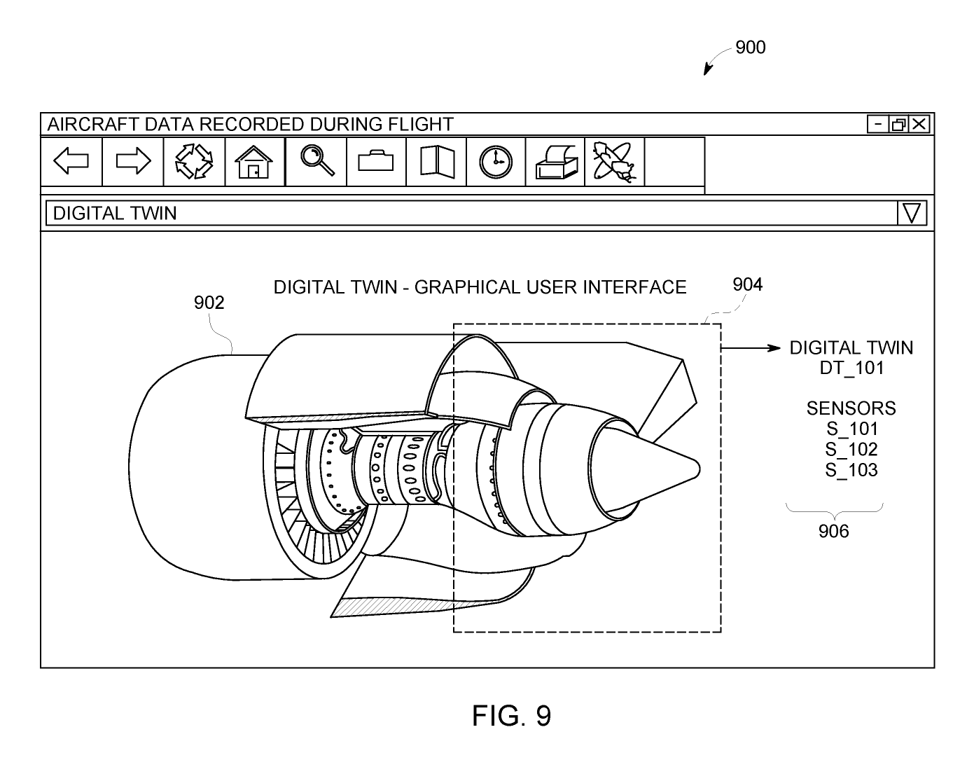

FIG. 9 illustrates an interactive graphical user interface display 900 according to some embodiments. The display 900 may include a graphical rendering 902 of a twinned physical object and a user selectable area 904 that may be used to identify portions of a digital twin associated with that physical object. A data readout area 906 might provide further details about the select portions of the digital twins (e.g., sensors within those portion, data values, etc.).

Thus, some embodiments may provide systems and methods to facilitate predictive model building, assessments and/or predictions for a physical system in an automatic and accurate manner.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems). For example, although some embodiments are focused on EGT, any of the embodiments described herein could be applied to other engine factors related to hardware deterioration, such as engine fuel flow, and to non-engine implementations.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A system associated with predictive modeling of an industrial asset, comprising:
a database storing at least one electronic file containing a machine learning library and predictive modeling tools associated with the industrial asset;
a modeling platform comprising a computer processor operatively connected to the database, the computer processor configured to:
access the machine learning library and predictive modeling tools associated with the industrial asset;
provide a model building framework user interface to a user;
receive a selection of a feature engineering (FE) technique comprising one of evolutionary feature selection, evolutionary feature synthesis, and symbolic regression;
provide an input selection interface based on the selected FE technique;
receive industrial asset input data and parameter data via the input selection interface from the user;
execute at least one of an evolutionary feature selection process, an evolutionary feature synthesis process, and a symbolic regression process and generate output data for the industrial asset; and
generate at least one of feature selection output data and provide feature rankings output data; and
an output device operably connected to the computer processor for receiving and presenting at least one of the generated feature selection output data and the feature rankings output data associated with a predictive model of the industrial asset.

2. The system of claim 1, further comprising a communication port coupled to the computer processor to transmit at least one of the feature selection output data and the feature rankings output data associated with a predictive model of the industrial asset to a user platform.

3. The system of claim 1, wherein the selected feature engineering (FE) technique is evolutionary feature selection and the computer processor provides an input interface comprising inputs for a plurality of input parameters associated with the industrial asset, a number of generations input, and inputs for advanced algorithm parameters.

4. The system of claim 3, wherein the advanced algorithm parameters comprise at least two of a Number of Features Weight, an Algorithm Performance Weight, a Number of Children to Produce at Each Iteration, a Number of Individuals to Select for Next Generation, a Crossover Probability, and a Mutation probability.

5. The system of claim 3, further comprising a problem type input and an approximate regression model or train model input for each individual.

6. The system of claim 1, wherein providing feature selection output data comprises providing at least one of output graph depicting a number of features versus accuracy data and a table listing the features, number of features and accuracy data.

7. The system of claim 1, wherein the selected feature engineering (FE) technique is evolutionary feature synthesis and the computer processor provides an input selection interface comprising inputs for a plurality of input parameters associated with the industrial asset, a number of generations input, and advanced algorithm parameter inputs.

8. The system of claim 7, wherein the advanced algorithm parameters comprise at least two of an Information Gain Objective Weight, a Complexity of Expressions Objective Weight, a Number of Children to Generate at Each Iteration, a Number of Individuals to Select for Next Generation, a Feature Interaction Level, a Crossover Probability, a Mutation probability, and a Random Seed.

9. The system of claim 7, wherein providing feature synthesis output data comprises providing at least one of an output graph of Feature Importance of Pareto Optimal features, an output graph of Information Gain of Pareto Optimal features, and an output graph of Information Gain of Positive and Negative Samples.

10. The system of claim 1, wherein the selected feature engineering (FE) technique is symbolic regression and the computer processor provides an input selection interface comprising inputs for a plurality of input parameters associated with the industrial asset, a number of generations input, and inputs for advanced algorithm parameters.

11. The system of claim 10, wherein the advanced algorithm parameters comprise at least two of a Number of Generations input, a Threshold for Assigning Classes input, a Maximum Tree Depth of Selected Individuals input, a Maximum Tree Depth During Mutation input, a Minimum Tree Depth During Mutation input, a Maximum Tree Depth During Crossover input, a minimum Tree Depth During Crossover input, a True Positive Rate Weight, a True Negative Rate Weight, a Number of Children to Produce at Each Iteration, a Number of Individuals to Select for Next Generation field, a Crossover Probability, a Mutation Probability, and a Random Seed.

12. The system of claim 1, wherein providing symbolic regression output data comprises the computer processor providing at least one of output graph depicting the true positive rate (TPR) versus the true negative rate (TNR), and an Accuracy vs. Complexity graph.

13. A computerized method associated with predictive modeling of an industrial asset, comprising:
accessing, by a computer processor, a machine learning library and predictive modeling tools associated with an industrial asset;
providing, by the computer processor, a model building framework user interface associated with the industrial asset to a user;
receiving, by the computer processor, a selection of a feature engineering (FE) technique comprising one of evolutionary feature selection, evolutionary feature synthesis, and symbolic regression;
providing, by the computer processor, an input selection interface based on the selected FE technique;
receiving, by the computer processor, industrial asset input data and parameter input data via the input selection interface from the user;
executing, by the computer processor, at least one of an evolutionary feature selection process, an evolutionary feature synthesis process, and a symbolic regression process and generate output data for the industrial asset; and
providing, by the computer processor, at least one of feature selection output data and feature rankings output data associated with a predictive model of the industrial asset for consideration by a user.

14. The method of claim 13, further comprising transmitting, by the computer processor, the at least one of the feature selection output data and the feature rankings output data associated with a predictive model of the industrial asset to a display component.

15. The method of claim 13, further comprising transmitting, by the computer processor via a communication port, at least one of the feature selection output data and the feature rankings output data associated with a predictive model of the industrial asset to a user platform.

16. The method of claim 13, wherein receiving the selected feature engineering (FE) technique comprises receiving an evolutionary feature selection and further comprising providing, by the computer processor, an input selection interface comprising inputs for a plurality of input parameters associated with the industrial asset, a number of generations input, and inputs for advanced algorithm parameters.

17. The method of claim 13, wherein providing feature selection output data comprises providing, by the computer processor, at least one of output graph depicting a number of features versus accuracy data and a table listing the features, number of features and accuracy data.

18. The method of claim 13, wherein receiving the selected feature engineering (FE) technique comprises receiving selection of an evolutionary feature synthesis technique and further comprising providing, by the computer processor, an input selection interface comprising inputs for a plurality of input parameters associated with the industrial asset, a number of generations input, and advanced algorithm parameter inputs.

19. The method of claim 13, wherein the selected feature engineering (FE) technique is symbolic regression and further comprising providing, by the computer processor, an input selection interface comprising inputs for a plurality of input parameters associated with the industrial asset, a number of generations input, and inputs for advanced algorithm parameters.

20. The method of claim 13, wherein providing symbolic regression output data comprises providing, by the computer processor, at least one of output graph depicting the true positive rate (TPR) versus the true negative rate (TNR), and an Accuracy vs. Complexity graph.
